(19) United States
(12) Patent Application Publication
(10) Pub. No.: US 2016/0110774 A1
(43) Pub. Date: Apr. 21, 2016

(54) METHOD AND APPARATUS FOR RECOMMENDING AFFILIATED STORE BY USING REVERSE AUCTION

(71) Applicant: SEEON CO., LTD., Seoul (KR)

(72) Inventor: Byung-ik AHN, Seongnam-si (KR)

(21) Appl. No.: 14/773,552

(22) PCT Filed: Mar. 3, 2014
(86) PCT No.: PCT/KR2014/001731

§ 371 Date: Dec. 15, 2015

(30) Foreign Application Priority Data
Mar. 8, 2013 (KR) 10-2013-0025271
Feb. 17, 2014 (KR) 10-2014-0018022

(51) Int. Cl. G06Q 30/02; G06Q 30/06; G06Q 50/12

(52) U.S. Cl. CPC G06Q 30/0275; G06Q 50/12; G06Q 30/0631

(57) ABSTRACT

A method and an apparatus for recommending a business by using a reverse auction are provided. The method and the apparatus for recommending a business by using a reverse auction intermediate a satisfying deal between a user and a business through a reverse auction scheme by using a user's check-in information on a location-based social network service.

### TECHNICAL FIELD

Some embodiments of the present disclosure relate to a method and an apparatus for recommending a business by using a reverse auction.

### BACKGROUND

The statements in this section merely provide background information related to the present disclosure and do not necessarily constitute prior art.

Due to advances in communication technology and services and an evolution of a terminal such as a mobile phone, a personal digital assistant (PDA), a notebook computer, and the like, a location based service (LBS) is established as one of the service fields with high growth potential. The LBS is a service system that offers a variety of services to users based on (or in connection with) a location information obtained through a mobile communication network, a global positioning system (GPS), or the like. Further, the LBS refers to a service system having a terminal installed with a chip linked to a base station or GPS to provide various location-related services such as a location tracking service, a public safety service, a location based information service, and the like. The LBS offers various services based on a location information obtained through a GPS or wired/wireless communication network. For example, the LBS allows a user to check an information of businesses located near the terminal by a software application of the LBS installed in the terminal.

Recent advances in communication technology allows the current location of a terminal to be utilized by businesses at relevant locations for offering discount coupons and the like to the terminal of a prospective customer. The terminal user is expected to visit the prescribed business to get the benefit of discount by presenting the discount coupon transmitted to the terminal. However, the expected customer, when looking to such businesses and trying to find the agreeable one, takes the trouble of identifying the individual businesses responsible for issuing the discount coupons before determining the business satisfying the terms of the customer.

### DISCLOSURE

### Technical Problem

Some embodiments of the present disclosure provide a method and an apparatus for recommending a prescribed shop by using a reverse auction, which intermediates a satisfying deal between a user and a business through a reverse auction scheme by using a user's check-in information on a location-based social network service.

### SUMMARY

In accordance with some embodiments of the present disclosure, an apparatus for recommending a business includes a venue recommendation unit configured to receive a transaction information with respect to a menu content from a terminal, and generate a venue recommendation information based on a bidding information corresponding to the transaction information, a business recommendation unit configured to identifies, from the generated venue recommendation information, a business recommendation information matching a preference information corresponding to a subscriber information of the terminal, a reverse auction provider configured to transmit the business recommendation information to the terminal through a reverse auction scheme, and an award processor configured to perform an award (successful bid) process of a selection information selected from the business recommendation information, and transmit an award information to a business terminal corresponding to the selection information.

Further, in accordance with some embodiments of the present disclosure, a method for recommending a business by a business recommending apparatus, includes: performing a venue recommendation including: receiving a transaction information with respect to a menu content from a terminal, and generating a venue recommendation information based on a bidding information corresponding to the transaction information; performing a business recommendation, including discriminating a business recommendation information matching a preference information corresponding to a subscriber information of the terminal from the venue recommendation information; providing a reverse auction, including transmitting the business recommendation information to the terminal through a reverse auction scheme; and performing an award process including: awarding a selection information selected from the business recommendation information, and transmitting an award information to a business terminal corresponding to the selection information.

### Advantageous Effects

Some embodiments of the present disclosure as described above can intermediate a satisfying deal between a user and a shop or business through a reverse auction scheme by using a user's check-in information on a location-based social network service. According to the present disclosure, a customer can select the most suitable shop or business through a reverse auction scheme upon obtaining the information on businesses based on a current location of the customer.

Further, according to the present disclosure, the customer, who intends to visit a business, can select a business that offers better terms upon obtaining information of businesses who provide a sales event or free service satisfying current terms (a current location, a movement range, the number of participants, a visit time, a discount rate, and the like) of the customer in real time.

### BRIEF DESCRIPTION OF DRAWINGS

FIG. 1 is a schematic block diagram of a system for recommending a business by using a reverse auction, according to some embodiments.

FIG. 2 is a schematic block diagram of an apparatus for recommending a business, according to some embodiments.

FIG. 3 is a schematic block diagram of a subscriber administrator according to some embodiments.

FIG. 4 is a schematic block diagram of a preference analyzer, according to some embodiments.

FIG. 5 is a schematic block diagram of a venue recommendation unit, according to some embodiments.

FIG. 6 is a schematic block diagram of a business selector, according to some embodiments.

FIG. 7 is a diagram of a method for obtaining a weight for each category of a service provider, according to some embodiments.

FIG. 8 is a diagram of a method for calculating a distance between a current location of user U and a recommendation information, according to some embodiments.

FIG. 9 is a flowchart of an operational process of a business recommendation unit, according to some embodiments.

FIG. 10 is an exemplary diagram of a result of assigning a weight to a restaurant category by each user, according to some embodiments.

FIG. 11 is a diagram showing the similarities among user U, user 2, user 3 and user 4, according to some embodiments.

FIG. 12 is a diagram of predicted evaluation values according to some embodiments.

FIG. 13 is a measurement results of distance scores depending on distances among a current location of user U and recommended cafés, according to some embodiments.

FIG. 14 is a diagram of recommended venues generated by applying ratios of the predicted evaluation values and the distance scores to recommended venue scores obtained by adding the predicted evaluation values and the distance scores, according to some embodiments.

FIG. 15 is an exemplary diagram according to some embodiments.

FIG. 16 is a flowchart of a method for recommending a business by using a reverse auction, according to some embodiments.

FIG. 17 is a flowchart of a method for performing a check-in operation for venues, according to some embodiments.

FIG. 18 is a flowchart of a method for reverse auction based on a community service, according to some embodiments.

FIG. 19 is a flowchart of a method for checking a user's preference, according to some embodiments.

FIG. 20 is an exemplary diagram of a transaction information according to some embodiments.

FIG. 21 is an exemplary diagram of a venue recommendation information and a business recommendation information according to some embodiments.

### DETAILED DESCRIPTION

Hereinafter, at least one embodiment of the present disclosure will be described in detail with reference to the accompanying drawings.

Various types of information described in some embodiments of the present disclosure are defined as follows. A ‘transaction information’ refers to an information registered (input) by a terminal 110 and refers to an information including various terms informations with respect to a menu content. A ‘bidding information’ refers to an information registered or transmitted by a business terminal 114 and refers to information including a terms information of a business. A ‘successful bid’ or ‘award information’ refers to an information indicating that a bidding information of the business terminal 114 is awarded (selected). A ‘preference information’ refers to all informations on preferences for each subscriber information of the terminal 110 and refers to an information including at least one of a ‘preference POI information’, a ‘preference local area information’, and a ‘preference menu information’. A ‘venue recommendation information’ refers to an information including a plurality of bidding information items corresponding to the transaction information received from the terminal 110. A ‘business recommendation information’ refers to an information matching the preference information of the venue recommendation information. Herein, it should be understood that term ‘business’ refers to any commercial entity having at least one point of sale, such as a shop, store, merchant, seller, trader, or the like. It may be a retail or a wholesale entity and may deal with goods or services.

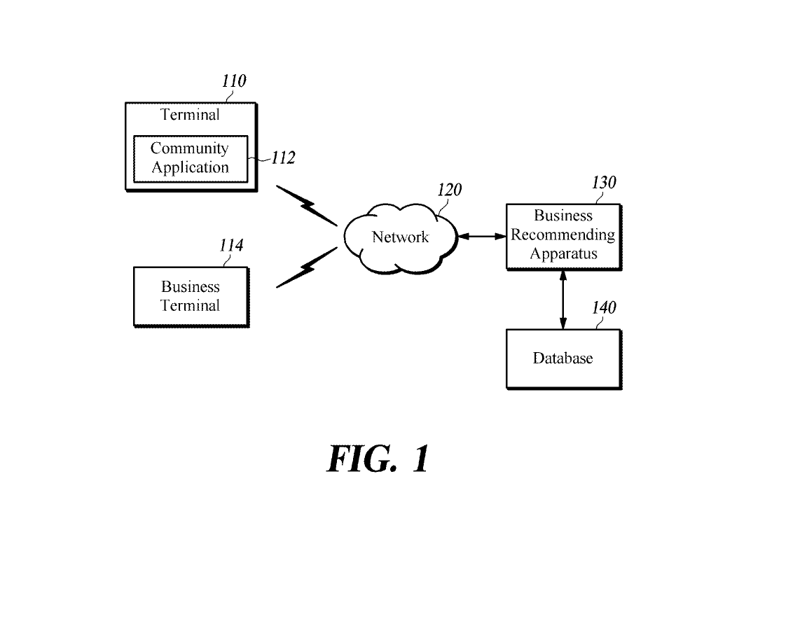

FIG. 1 is a schematic block diagram of a system for recommending a business by using a reverse auction according to some embodiments.

The system for recommending a business by using a reverse auction according to some embodiments includes a terminal 110, a business terminal 114, a network 120, an business recommending apparatus 130 and a database 140. The terminal 110 refers to a device that may transceive various data through the network 120 according to a user's key operation or command. The terminal 110 may be any one of a tablet PC, a laptop, a personal computer (PC), a smart phone, a personal digital assistant (PDA), a mobile communication terminal, and the like. The terminal 110 may be a cloud computing terminal supporting cloud computing that enables the use of services such as reading, writing, and storing data, offering a network and contents for use, and the like through the network 120.

The terminal 110 is a device that performs voice or data communications using the network 120. The terminal 110 refers to a device including a memory for storing a program or a protocol for communicating with the business recommending apparatus 130 through the network 120, a microprocessor for performing an operation and a control by executing the program, and the like. Any device may be used as the terminal 110 as long as it performs server-client communications with the business recommending apparatus. The terminal 110 may include any communication computing device such as a notebook computer, a mobile communication terminal, a PDA, and the like. In the meantime, some embodiments describe that the terminal 110 is implemented by a separate device from the business recommending apparatus 130, but in the actual implementation of some embodiments, the terminal 110 may be implemented by a stand-alone device including the business recommending apparatus 130.

The terminal 110 may be a terminal including a global positioning system (GPS) module but is not necessarily limited thereto. The terminal 110 extracts navigation data from a GPS radio signal received from one or more GPS satellites by using the GPS module included in the terminal 110 and then transmits the navigation data to a separate positioning device via the network 120. Further, the terminal 110 may be a terminal equipped with a wireless LAN module for use in transceiving various data by accessing the Internet through a nearby access point (AP) recognized (scanned). The terminal 110 may be equipped with at least one of a wireless communication module, a GPS module, and a wireless LAN module, but is not necessarily limited thereto. The terminal 110 calculates a current location information by using the GPS module in an outdoor environment. Indoors, the terminal 110 calculates the current location information through base station-positioning by using the wireless communication module or calculates the current location information through wireless LAN-positioning by using the wireless LAN module.

According to some embodiments, the terminal 110 may be equipped with a community application 112 to exploit a location based community service, e.g., a social network service (SNS). The terminal 110 executes the community application 112 by a user's operation or command. The terminal 110 uses the location based community service through the community application 112. When the terminal 110 is a smart phone, the community application 112 is installed after being downloaded from an application store. When the terminal 110 is a feature phone, the community application 112 may be executed on a virtual machine (VM) downloaded from a server of a communication company. The following describes a form of the community application 112 mounted in the terminal 110 according to some embodiments. The community application may be implemented in the terminal 110 in the form of embedded application, in the form of being embedded in the operating system (OS) by default, or in the form of being installed in the OS by a user's operation or command. The community application 112 installed in the terminal 110 may be implemented to interoperate with an installed basic application in the terminal 110 (for example, a text message transmission application, a voice call transceiving application, a date transceiving application, a messenger application, and the like), but is not necessarily limited thereto. The community application 112 may be independently operated without being linked with the basic application.

The following describes a process of performing a location based community service (SNS) by using the community application 112 installed in the terminal 110. The terminal 110 executes the installed community application 112, e.g., according to a user's operation or command. The terminal 110 transmits a transaction information (budget information, information on the number of participants, date information, memo information, and information on the radius of a location with respect to a specific menu content) to the community application 112 executed by the user's operation or command. The terminal 110 transmits the transaction information to the business recommending apparatus 130 by using the community application 112. The terminal 110 receives and displays a business recommendation information and a venue recommendation information corresponding to the transaction information from the business recommending apparatus 130.

The terminal 110 aligns (in an ascending order or a descending order) and displays the business recommendation information and the venue recommendation information according to specific terms (a menu information, the budget information, the participant number information, the date information, the memo information, and the location radius information) by using the community application 112. The terminal 110 selects any one of the business recommendation informations according to the user's operation or command as a selection information. The terminal 110 transmits the selection information to the business recommending apparatus 130 by using the community application 112. The terminal 110 receives and displays an award information regarding the selection information from the business recommending apparatus 130 by using the community application 112. Here, the award information is an information indicating that the bidding Information of the corresponding business terminal 114 is selected.

The community application 112 refers to a software application providing a kind of location based community service (SNS). A method for executing the community application 112 will now be described. The community application 112 is independently operated while having a separate software function or hardware function performed by the terminal 110 or implemented to interoperate with a separated software function or hardware function performed by the terminal 110. The community application 112 may be installed in the terminal 110 to operate by using various hardware included in the terminal 110, but is not necessarily limited thereto. The community application 112 may be implemented by a separate device to operate. Further, the community application 112 may interoperate with applications previously installed within the terminal 110.

An operation performed by the community application 112 will now be described. The community application 112 refers to a kind of program which is installed within the terminal 110 and performs a location based community service (SNS). The community application 112 transmits, to the business recommending apparatus 130, the transaction information (the budget information, the participant number information, the date information, the memo information, and the location radius information with respect to the specific menu content) input by the user's operation or command. The community application 112 receives and displays the business recommendation information and the venue recommendation information corresponding to the transaction information from the business recommending apparatus 130, on the terminal 110. The community application 112 displays, on the terminal 110, the business recommendation information and the venue recommendation information after aligning them in an ascending or descending order according to specific terms (the menu information, the budget information, the participant number information, the date information, the memo information, and the location radius information). The community application 112 generates a selection information which is selected from the business recommendation informations through the user's command. The community application 112 transmits the selection information to the business recommending apparatus 130. The community application 112 receives an award information regarding the selection information from the business recommending apparatus 130 and displays the award information on the terminal 110.

The business terminal 114 refers to a device for transceiving various data via the network 120 according to the user's key operation. The business terminal 114 may be any one of a tablet PC, a laptop, a PC, a smart phone, a PDA, a mobile communication terminal, and the like. The business terminal 114 is a terminal that performs voice or data communications through the network 120. The business terminal 114 refers to a device including a memory for storing a program or a protocol for communicating with the business recommending apparatus 130 through the network 120, a microprocessor for performing an operation and a control by executing the corresponding program, and the like. As the business terminal 114, any terminal may be used as long as it enables server-client communications with the business recommending apparatus 130 and encompasses all communication computing devices such as a notebook computer, a mobile communication terminal, a PDA, and the like.

According to some embodiments, the business terminal 114 transmits (or registers) bidding informations (a business information, an address information, a telephone number information, a menu picture information, a flagship dish information, an open hours information, a price terms information, a discount rate information, and a location radius information). When the transaction information is received from the terminal 110, the business terminal 114 may be configured to automatically transmit a bidding information corresponding to the transaction information to the terminal 110. When an ‘automatic bidding’ is set through a user's command after the business terminal 114 is linked to the business recommending apparatus 130, the business terminal 114 may perform the automatic bidding based on a terms information included in the bidding informations registered by the business terminal 114. In the meantime, the business terminal 114 may receive the transaction information from the business recommending apparatus 130 in real time and then transmit the bidding information corresponding to the transaction information to the business recommending apparatus 130 by an administrator's command.

The network 120 includes a 3G network, a 4G network, a wireless LAN, the Internet, an intranet, a satellite communication network, and the like. The network 120 transceives data by a communication protocol by using various wired/wireless communication technologies. Further, the network 120 includes a cloud computing network which is connected with the business recommending apparatus 130 to store a computing resource such as hardware and software, and provide the computing resource required by a client to the corresponding terminal 110. The cloud computing refers to a computer environment in which an information is stored in a server on the Internet and temporarily stored in a client terminal such as a desktop, a tablet computer, a notebook computer, a netbook, a smart phone, and the like. A hardware implementation of the business recommending apparatus 130 has a similar configuration as a general web server or network server. Whereas, a software implementation of the business recommending apparatus 130 includes a program module which is implemented by program languages such as C, C++, Java, Visual Basic, Visual C, and the like. The business recommending apparatus 130 may be implemented in a form of a web server or network server. The web server may mean computer software (or web server program) which is connected to a plurality of random clients or other servers via an open computer network such as the Internet, receives a request to perform tasks from the clients or other web servers, and derives the performed results. The business recommending apparatus 130 may be implemented by using web server programs which are variously provided depending on operating systems such as DOS, windows, Linux, UNIX, and Macintosh in hardware for a general server. The business recommending apparatus 130 interworks with an authentication system and a settlement system for a community service (SNS).

The following describes an operational process of the business recommending apparatus 130 according to some embodiments. The business recommending apparatus 130 receives a transaction information with respect to a menu content from the terminal 110. The business recommending apparatus 130 generates a venue recommendation information based on a bidding Information corresponding to the transaction information. The business recommending apparatus 130 identifies, from the generated venue recommendation information, a business recommendation information matching a preference information corresponding to a subscriber information of the terminal 110. The business recommending apparatus 130 transmits the business recommendation information to the terminal 110 through a reverse auction scheme. Then, the business recommending apparatus 130 performs an award (successful bid) process of a selection information selected from the business recommendation information and transmits an award information to the business terminal 114 corresponding to the selection information. Here, the transaction information includes a budget information, a participant number information, and a date information as a requisite information, and includes a memo information and a location radius information as an optional information. Further, the bidding information includes at least one of a business information, an address information, a telephone number information, a menu picture information, a flagship dish information, an open hours information, a price terms information, a discount rate information, and a location radius information.

The following describes a process of building a community with respect to the subscriber information of the terminal 110 by the business recommending apparatus 130. The business recommending apparatus 130 stores the subscriber information of the terminal 110 subscribing to a community service (SNS). The business recommending apparatus 130 generates an information on a result of retrieving a point of interest (POI) within a preset range based on a current location information of the terminal 110. The business recommending apparatus 130 selects, from the information on the retrieval result, a POI to which a review information or venue evaluation information is assigned, based on the subscriber information and performs a check-in operation. The business recommending apparatus 130 calculates and stores a preference information based on the review information or the venue evaluation information. The business recommending apparatus 130 shares the review information or the venue evaluation information among the terminal 110 and terminals of other subscribers to build a community.

A process of analyzing a preference of a subscriber of the terminal 110 by the business recommending apparatus 130 will now be described. The business recommending apparatus 130 identifies a check-in pattern for the check-in. The business recommending apparatus 130 calculates a similarity pattern between subscriber informations based on the check-in pattern. The business recommending apparatus 130 extracts a like-kind or a similar subscriber information based on the similarity pattern. The business recommending apparatus 130 produces at least one of a preference POI information, a preference local area information, and a preference menu information with respect to the like-kind subscriber information as a preference information.

The following describes a process of recommending a plurality of venues in response to a user's request by the business recommending apparatus 130. The business recommending apparatus 130 extracts, among the previously registered business informations, an information corresponding to a transaction information received from the terminal 110, as a bidding information or receives a bidding Information from the business terminal 114 in real time. The business recommending apparatus 130 extracts, from a terms information included in the previously registered business information, an information coinciding with a preset terms information included in the transaction information within a preset range, as a bidding information. Further, the business recommending apparatus 130 receives a current location information from the terminal 110 and transmits the transaction information to the business terminal 114 located within a preset range based on the current location information. Further, the business recommending apparatus 130 collects the bidding Information, and then filters a business information out of the preset range based on the current location information received from the terminal 110 to generate a venue recommendation information. The business recommending apparatus 130 transmits, to the terminal 110, the business recommendation information after aligning the same according to the preset terms information. Further, the business recommending apparatus 130 receives a selection information from the terminal 110. The business recommending apparatus 130 performs an award process of a business information corresponding to the selection information from the business recommendation information, and transmits an award information to the business terminal 114 corresponding to the business information.

The business recommending apparatus 130 analyzes a natural language included in the transaction information and generates a natural language analysis result. The business recommending apparatus 130 extracts, from the terms information included in the previously registered business information, an information coinciding with the natural language analysis result within a preset range, as a bidding information. In this case, a process of analyzing the natural language by the business recommending apparatus 130 may be described in detail as follows. The business recommending apparatus 130 classifies and stores natural language words or phrases under classified heads which include at least one of the terms informations contained in the previously registered business information. The business recommending apparatus 130 figures out the natural language words and syntaxes included in the transaction information and converts them into a basic information. The business recommending apparatus 130 identifies, among the basic form of sentence, the words or the syntaxes matching the previously stored information, as a matching information. The business recommending apparatus 130 applies a probabilistic model based on co-occurrence of the matching informations and analyzes the natural language in accordance with the applied probabilistic model.

A process of recommending a business according to a preference by the business recommending apparatus 130 will now be described. The business recommending apparatus 130 calculates a preference information based on a review information or a venue evaluation information corresponding to the subscriber information of the terminal 110. The business recommending apparatus 130 calculates a preference POI information based on a POI information included in the review information or the venue evaluation information or calculates a preference local area information based on a local area information included in the review information or the venue evaluation information, or calculates a preference menu information based on the menu information included in the review information or the venue evaluation information. Then, with respect to the calculated preference POI information, preference local area information and preference menu information, the business recommending apparatus 130 selects at least one coincident information from the POI information, the local area information and the menu information included in the venue recommendation information, as a business recommendation information.

The database 140 is a storage means that stores various data required for executing the business recommending apparatus 130. The database 140 basically interoperates with the business recommending apparatus 130 to manage stored data. The database 140 classifies and manages a membership information of a community service (SNS) and an information on the community service (SNS). Further, the database 140 stores an information on at least one of a ‘venue database’ storing the POI information, a ‘check-in database’ storing the check-in information, a ‘preference database’ storing the preference information, a ‘business database’ storing the business information, a ‘recommendation database’ storing the venue recommendation information or business recommendation information, a ‘user database’ storing a subscriber information, and the like. In the meantime, the database 140 may be a separate apparatus from the business recommending apparatus 130, but is not necessarily limited thereto. The database 140 may be implemented inside or outside the business recommending apparatus 130.

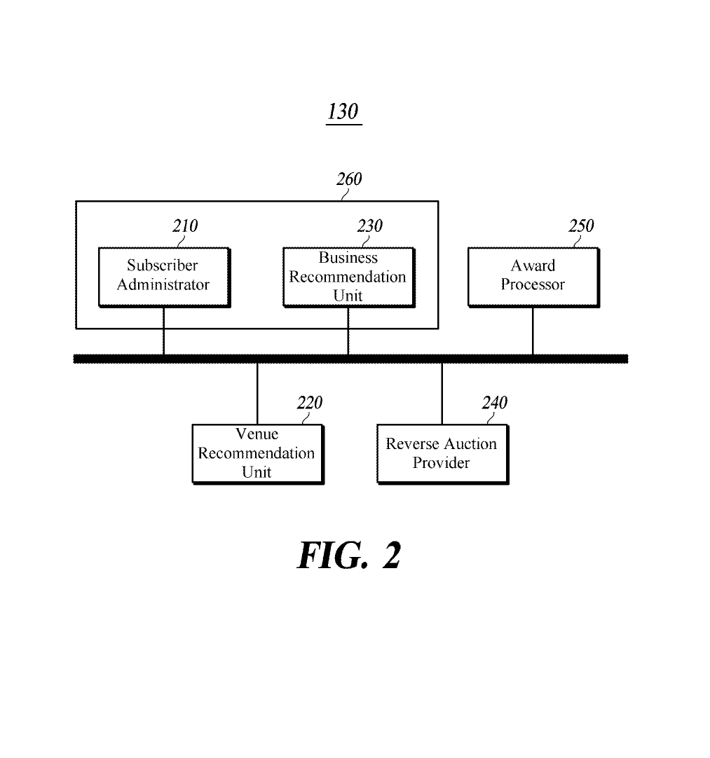

The database 140 refers to an ordinary data structure implemented in a storage space (hard disk or memory) of a computer system by using a database management system (DBMS). The database 140 refers to a date storage format for freely retrieving (extracting), deleting, editing, and adding data. The database 140 may be implemented by using Oracle, Infomix, Sybase, a relational database management system (RDBMS), Gemston, Orion, an object-oriented database management system (OODBMS), Excelon, Tamino, Sekaiju, and the like. FIG. 2 is a schematic block diagram of an apparatus for recommending a business according to some embodiments.

The business recommending apparatus 130 according to some embodiments includes a subscriber administrator 210, a venue recommendation unit 220, a business recommendation unit 230, a reverse auction provider 240 and an award processor 250. The subscriber administrator 210 stores a subscriber information of the terminal 110 subscribing to the community service. The subscriber administrator 210 generates an information on a result of retrieving a POI within a preset range based on a current location information of the terminal 110. The subscriber administrator 210 selects and checks in a POI to which the review information or the venue evaluation information is assigned based on the subscriber information from the information on the retrieval result. The subscriber administrator 210 calculates a preference information based on the review information or the venue evaluation information. The subscriber administrator 210 shares the review information or the venue evaluation information among the terminal 110 and terminals of other subscribers to build a community. Further, the subscriber administrator 210 identifies a check-in pattern for check-in operations. The subscriber administrator 210 calculates a similarity pattern between subscriber informations based on the check-in pattern. The subscriber administrator 210 extracts like-kind subscriber informations based on the similarity pattern. The subscriber administrator 210 calculates at least one of the preference POI information, a preference local area information and a preference menu information with respect to the like-kind subscriber information, as a preference information.

The venue recommendation unit 220 receives, from the terminal 110, a transaction information with respect to a menu content. The venue recommendation unit 220 generates a venue recommendation information based on a bidding information corresponding to the transaction information. The venue recommendation unit 220 extracts, from the previously registered business information, an information corresponding to the transaction information as the bidding information or it receives the bidding information from the business terminal 114 in real time. Further, the venue recommendation unit 220 extracts, from the terms information included in the previously registered business information, an information coinciding with the preset terms information included in the transaction information within a preset range, as a bidding information. Further, the venue recommendation unit 220 receives the current location information from the terminal 110, and transmits the transaction information to the business terminal 114 located within the preset range based on the current location information. Further, the venue recommendation unit 220 collects the bidding information and filters a business information out of the preset range based on the current location information received from the terminal 110 to generate a venue recommendation information.

A process of analyzing a natural language by the venue recommendation unit 220 will be described. The venue recommendation unit 220 analyzes the natural language included in the transaction information to generate a natural language analysis result. The venue recommendation unit 220 extracts an information coinciding within a preset range with the natural language analysis result from the terms information included in the previously registered business information as a bidding information. The venue recommendation unit 220 classifies and stores natural language words or phrases under classified heads which include at least one of the terms informations contained in the previously registered business information. The venue recommendation unit 220 figures out the natural language words and syntaxes included in the transaction information and converts them into a basic information. The venue recommendation unit 220 identifies, among the basic form of sentence, the words or syntaxes matching those in the stored information, as a matching information.

The business recommendation unit 230 identifies, from the generated venue recommendation information, a business recommendation information matching the preference information corresponding to the subscriber information of the terminal 110. The business recommendation unit 230 calculates a preference information based on a review information or a venue evaluation information corresponding to the subscriber information. The business recommendation unit 230 calculates a preference POI information based on the POI information included in the review information or the venue evaluation information, calculates a preference local area information based on the local area information included in the review information or the venue evaluation information, or calculates a preference menu information based on the menu information based on the review information or the venue evaluation information. With respect to the calculated preference POI information, preference local area information and preference menu information, the business recommendation unit 230 selects at least one coincident information from the POI information, the location information, and the menu information included in the venue recommendation information, as a business recommendation information.

The subscriber administrator 210 and the business recommendation unit 230 may be implemented as a business selector 260 that is a single module.

The reverse auction provider 240 transmits the business recommendation information to the terminal 110 through a reverse auction scheme. The reverse auction provider 240 aligns the business recommendation information items according to the preset terms information and transmits the aligned business recommendation information items to the terminal 110. The award processor 250 receives a selection information from the terminal 110. The award processor 250 performs an award process of a business information corresponding to the selection information from the business recommendation information. The award processor 250 transmits an award information to the business terminal 114 corresponding to the business information.

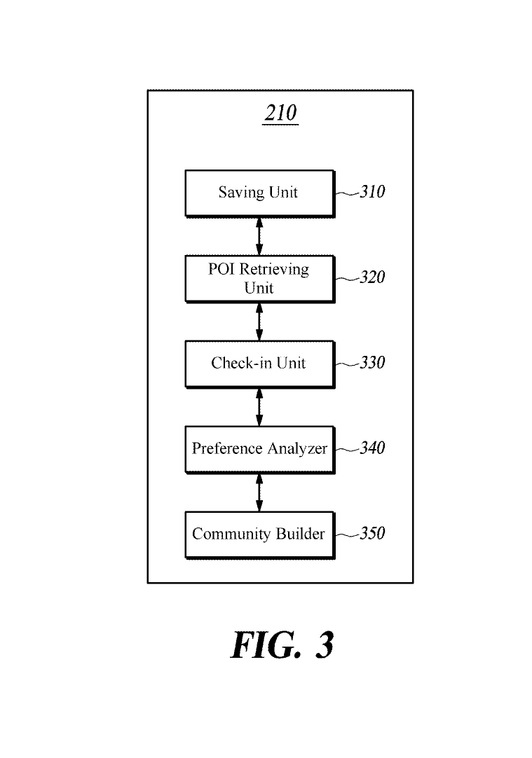

FIG. 3 is a schematic block diagram of a subscriber administrator according to some embodiments.

A subscriber administrator 210 according to some embodiments includes a saving unit 310, a POI retrieving unit 320, a check-in unit 330, a preference analyzer 340, and a community builder 350.

The saving unit 310 stores a subscriber information of the terminal 110 subscribing to a community service. It is basically required to subscribe to a community service (SNS) for using the community application 112 installed in the terminal 110, and thus the saving unit 310 of the business recommending apparatus 130 stores the subscriber information of the terminal 110 subscribing to the community service (SNS).

The POI retrieving unit 320 generates an information on a result of retrieving a POI within a preset range based on a current location information of the terminal 110. The check-in unit 330 selects, from the information on the retrieval result, POIs to which a review information or a venue evaluation information is given based on the subscriber information and performs a check-in operation. When the review information or the venue evaluation information is assigned to a particular POI information based on the subscriber information of the terminal 110, the check-in unit 330 of the business recommending apparatus 130 selects only the POIs corresponding to the particular POI information from the information on the retrieval result and performs a check-in operation.

The preference analyzer 340 calculates and stores a preference information based on the review information or the venue evaluation information. The preference analyzer 340 calculates and stores a preference POI information with respect to POIs to which the review information or the venue evaluation information is assigned, calculates and stores a preference local area information based on the local area information including the corresponding POI, or calculates and stores a preference menu information based on a menu information including the corresponding POI.

The community builder 350 shares the review information or the venue evaluation information among the terminal 110 and terminals of other subscribers to build a community. The term ‘community’ built by the community builder 350 refers to a community service (SNS). Here, the community service refers to a service that establishes a community relationship based on a social link associated with a POI corresponding to a user's location, shares an information such as an image, a text, a moving image, and the like, or provides communications that enable chatting, data transmission, advertisement, marketing, and holding an event.

Here, the user may establish a social relationship with others by using the terminal 110, inform a user's location to a terminal of a community service provider or terminals of others, and generate an information, such as an image, a text, a moving image, and the like related to the corresponding location. The community service provider serves to check whether the user subscribes to the community service, and establish a community relationship among users subscribing to the community service based on a social link associated with a POI. The community service provider provides various social links such as advertisement, marketing, holding an event, and chatting by using one POI. In this case, a surrounding POIs may be changed depending on a movement of the terminal 110, so that the community relationship established in the terminal 110 may be changed.

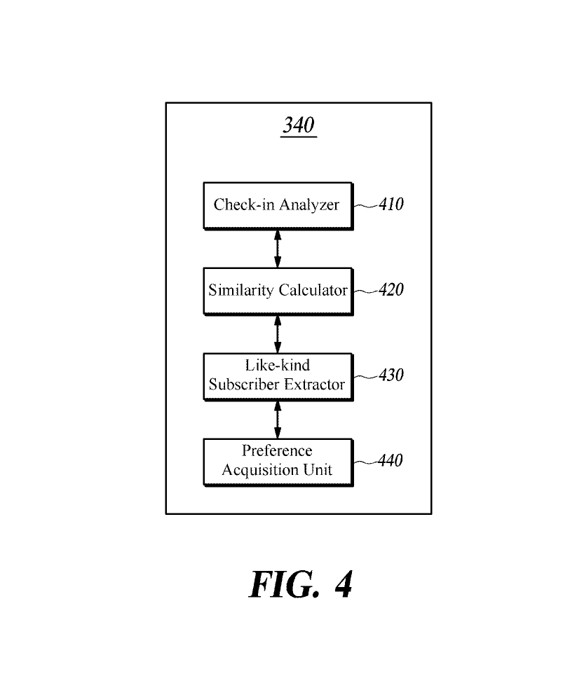

FIG. 4 is a schematic block diagram of a preference analyzer according to some embodiments.

A preference analyzer 340 according to some embodiments includes a check-in analyzer 410, a similarity calculator 420, a like-kind subscriber extractor 430, and a preference acquisition unit 440.

The check-in analyzer 410 identifies a check-in pattern for check-in operation. The check-in analyzer 410 identifies a check-in pattern in which a subscriber performs the check-in operation. The similarity calculator 420 calculates a similarity pattern among the subscriber informations based on the check-in pattern. The similarity calculator 420 performs a check-in operation at a POI to which the review information or the venue evaluation information is assigned based on the subscriber information of the terminal 110 in the community service (SNS), and collects corresponding check-in information, thereby identifying a check-in pattern. The similarity calculator 420 may select only a subscriber information of which a check-in pattern coincides with the identified check-in pattern by a preset percentage or more and calculate a similarity pattern between the corresponding subscribers.

The like-kind subscriber extractor 430 calculates a like-kind subscriber information based on the similarity pattern. The like-kind subscriber extractor 430 extracts an information of all subscribers having the calculated similarity patterns and groups the extracted subscriber information as a kind of group. The like-kind subscriber extractor 430 may extract the corresponding group as a like-kind subscriber information. The preference acquisition unit 440 calculates at least one of the preference POI information, a preference local area information, and a preference menu information with respect to the like-kind subscriber information as a preference information.

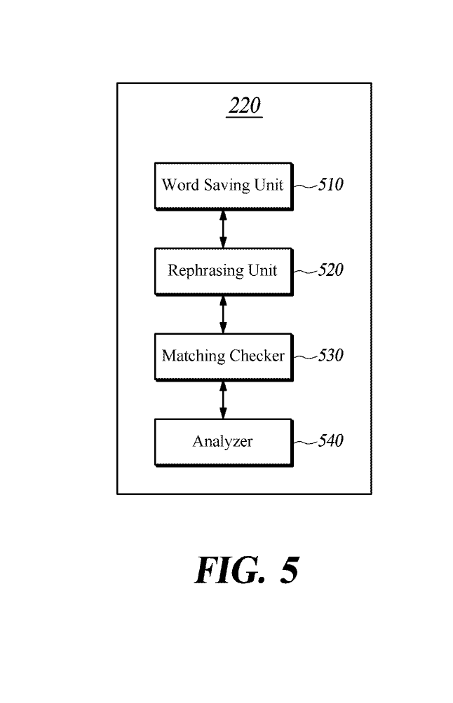

FIG. 5 is a schematic block diagram of a venue recommendation unit according to some embodiments.

A venue recommendation unit 220 according to some embodiments includes a word saving unit 510, a rephrasing unit 520, a matching checker 530, and an analyzer 540.

The word saving unit 510 classifies and stores natural language words or phrases under categories which include at least one of the terms informations contained in the previously registered business information. The word saving unit 510 holds classes including a basic group, under which preset words and sentences are classified, and subgroups obtained by subdividing the basic group. The word saving unit 510 classifies words or sentences by categories including at least one of similarity, degree of affirmation and negativity by using the basic group and the subgroups and stores the words or sentences as a kind of word dictionary. The word saving unit 510 may form a combined group obtained by combining the basic group and the subgroups.

The rephrasing unit 520 figures out words and syntaxes of the natural language included in the transaction information and converts the words and the syntaxes into a basic information. The rephrasing unit 520 figures out words and syntaxes of a sentence input (received) from the terminal 110 and converts the words and the syntaxes into a basic form. The rephrasing unit 520 primarily segments the sentence input (received) from the terminal 110 into a plurality of words and converts the words and the syntaxes into a basic form. The rephrasing unit 520 may recognize the syntaxes by using a combination of words commonly used among the segmented words and then convert the syntaxes into a basic form.

The matching checker 530 identifies words or syntaxes matching those in the word saving unit 510 in the basic sentence with a matching information. The matching checker 530 may compare the words and the syntaxes converted by the rephrasing unit 520 with words and syntaxes in a word dictionary stored in the word saving unit 510 to identify a word or a syntax matching the word or the syntax in the word dictionary. In the meantime, the matching checker 530 determines a grammatical part of speech of the language corresponding to the word and the syntax converted by the rephrasing unit 520. The matching checker 530 generates a weight reflecting information indicating that a preset weight depending on a part of speech is assigned to the converted word and syntax. When the matching checker 530 generates the weight reflecting information, the analyzer 540 may apply a probabilistic model based on co-occurrence of the weight reflecting information. The matching checker 530 may check a function of a part of speech to which each of the word and the syntax converted by the rephrasing unit 520 belongs, and assign a weight depending on the function. Here, the weight may also be expressed by an empirical numerical value.

The analyzer 540 applies the probabilistic model based on the co-occurrence of the matching information and analyzes the natural language according to the applied probabilistic model. For example, it is assumed that among the words converted into the basic form by the rephrasing unit 520, the words “more feast” and “quiet atmosphere” match “feast” and “quietness” in a word dictionary. The analyzer 540 may apply a probabilistic model based on a combination of the words “more feast” and “quiet atmosphere” and other words or syntaxes converted into a basic form and perform an analysis according to the applied probabilistic model. Here, the probabilistic model is an algorithm for calculating a probability that a specific word or syntax will belong to a specific group by using a frequency of the specific word or syntax in a whole corpus, and a calculation can be made for a probability that a new word will belong to a specific group based on the probabilistic model. Further, the analyzer 540 performs an analysis of (word+word), (word+syntax), and (syntax+syntax). The analyzer 540 may analyze the whole sentence by combining the analyzed words.

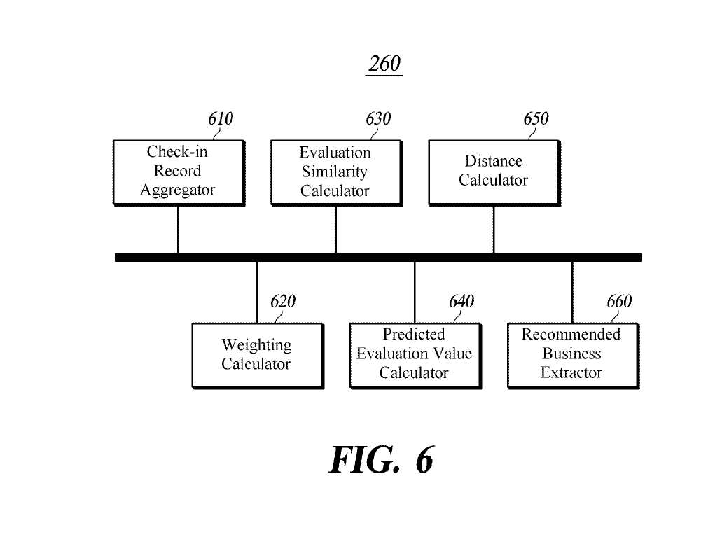

FIG. 6 is a schematic block diagram of a business selector according to some embodiments.

According to some embodiments, the business selector 260 includes a check-in record aggregator 610, a weight calculator 620, an evaluation similarity calculator 630, a predicted evaluation value calculator 640, a distance calculator 650, and a recommended business extractor 660. The check-in record aggregator 610 collects check-in record informations of service provider positioned at a preset location or within a preset area by the terminal 110. The check-in record aggregator 610 collects check-in record informations with respect to venue recommendation informations. The check-in record aggregator 610 classifies the venue recommendation informations by a service category and collects check-in record informations.

The weight calculator 620 receives the check-in record information from the check-in record aggregator 610, and calculates a weight for each venue recommendation information classified by the service category based on the check-in record information. A method for obtaining the weight by the weight calculator 620 is expressed by Equation 1 below. In the following description including Equation 1, a user V represents a user of a first terminal, and a user U represents a user of a second terminal. User 2, user 3, or user 4 represents a user using any one of a plurality of terminals.

$${W}_{vk} = {\sum }_{k = 1}^{m} {uf}_{vk} \qquad Equation 1$$

Wᵥₖ represents a weight of category k of the venue recommendation information shown in the check-in record information of user V. k=1, 2, 3, . . . , m represents the number of categories of the venue recommendation information checked-in by the user V. ufᵥₖ represents the number of occurrences of category k shown in the check-in record information of user V. When the number of occurrences of category k is larger, a higher weight is assigned.

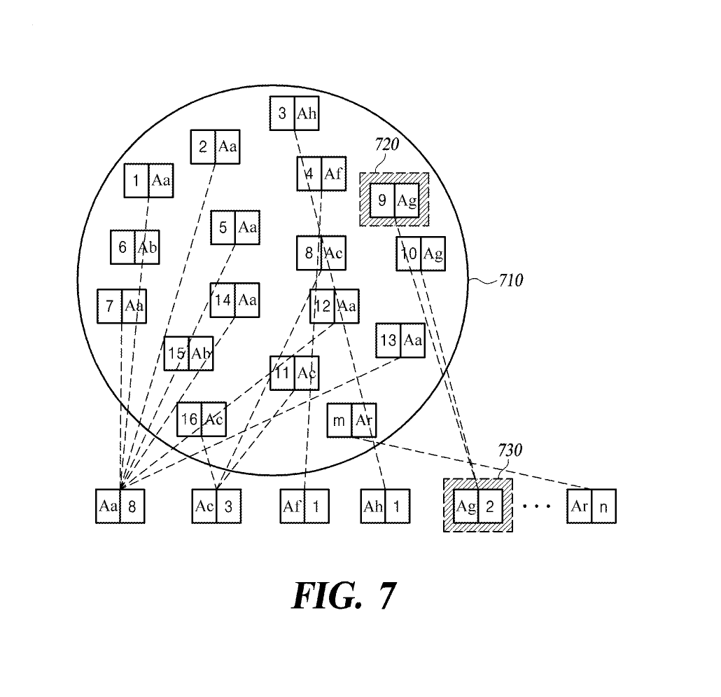

FIG. 7 is a diagram of a method for obtaining a weight of a service provider for each category according to some embodiments.

FIG. 7 shows a check-in record 720 within an area 710 which is set by the terminal 110. The check-in record 720 is a record indicating that user V performs a check-in operation within the area 710 preset in the terminal 110. The check-in record 720 including the record indicating that user V performs the check-in operation includes a category of the venue recommendation information and a user's visit order of the venue recommendation information. For example, the venue recommendation information includes a restaurant identification information. Table 1 shows category names of restaurants.

TABLE 1
Subcategory of Restaurant

| | |
|---|---|
| Aa | Hanjeongsik (Full-Course Korean Meal) |
| Ab | Samgyeopsal (Grilled Pork Belly) |
| Ac | Sparerib |
| Ad | Bulgogi |
| Ae | Ribeye |
| Af | Smoked Duck |
| Ag | Chopped Roast Chicken |
| Ah | Ginseng Chicken Soup |
| Ai | Korean Fried Chicken |
| Aj | Gopchang Gui (Grilled Beef Tripe) |
| Ak | Jokbal (Pigs' Trotters) |
| Al | Steakhouse |
| Am | Seafood |
| An | Japanese Food |
| Ao | Chinese Food |
| Ap | Curry |
| Aq | Shabu-Shabu |
| Ar | Bakery |
| As | Hamburger |
| At | Pizza |
| Au | Curry |
| Av | Fusion Restaurant |
| Aw | Italian Restaurant |
| Ax | French Restaurant |

As shown in Table 1, symbols Aa, Ab, . . . , Aw, and Ax are aligned to subcategories of restaurants, respectively, Here, the check-in record 720 indicating that user V performs the check-in operation shows that the subcategory of the restaurant is Ag, which represents a chopped roast chicken, and shows a ninth visit to the restaurant. From the check-in record 730 of user V, it can be seen that user V performs a check-in operation at the restaurant that serves the chopped roast chicken among the restaurants classified according to a category twice. From the check-in record 730 of user V, it can be seen how often user V visits the restaurant for each category, so that a weight for each category of the restaurant which each user visits may be calculated.

The evaluation similarity calculator 630 calculates a similarity between users based on an evaluation score determined with respect to the venue recommendation information by each user within a preset area. A method for calculating an evaluation similarity by the evaluation similarity calculator 630 is expressed by Equation 2 below.

$${W}_{uv} = \frac{{\sum }_{i = 1}^{m} ( {S}_{ui} - \overline{{S}_{u}} ) \times ( {S}_{vi} - \overline{{S}_{v}} )}{{σ}_{u} \times {σ}_{v}} \qquad Equation 2$$

Wᵤᵥ represents a similarity between user U and user V. Equation 2 limits the similarity between user U and user V, but similarities among all the users may be determined. i represents one of m venue recommendation informations. Sᵤᵢ represents an evaluation score obtained by evaluating a first service provider i by user U. Sᵥᵢ represents an evaluation score obtained by evaluating the first service provider i by user V. Sᵤ represents an average score of evaluation scores obtained by evaluating venue recommendation informations within a preset area by user U. Sᵥ represents an average score of evaluation scores obtained by evaluating venue recommendation informations within a preset area by user V. σᵤ represents a standard deviation of the evaluation scores obtained by evaluating the venue recommendation informations in the preset area by user U. σᵥ represents a standard deviation of the evaluation scores obtained by evaluating the venue recommendation informations about venues within the preset area by user V. It can be understood that when Wᵤᵥ, that is similarity between user U and user V, is closer to 0, a similarity between user U and user V is higher.

The predicted evaluation value calculator 640 calculates a predicted evaluation value by predicting a preference of a specific user for the venue recommendation information within a preset area. Here, the predicted evaluation value of the specific user is calculated based on an evaluation score of a specific venue recommendation information evaluated by the specific user, an average evaluation score of a specific venue recommendation information within an area of the specific user, and similarities among the specific user and other users. This case uses evaluation scores evaluated by other users having the same weight with respect to a category for each venue recommendation information. A method for calculating an predicted value by the predicted evaluation value calculator 640 is expressed by Equation 3 below.

$${P}_{uj} = \overline{{S}_{u}} + \frac{{\sum }_{j = 1}^{m} ( {S}_{vj} - \overline{{S}_{v}} ) \times {W}_{uv}}{{\sum }_{j = 1}^{m} {M}_{uv}} \qquad Equation 3$$

Pᵤⱼ represents a predicted evaluation value of user U with respect to a second service provider j. j refers to one of m venue recommendation informations to be recommended. Sᵤ represents the average score of the evaluation scores obtained by evaluating the venue recommendation informations about venues within the preset area by user U. Sᵥ represents the average score of the evaluation scores obtained by evaluating the venue recommendation informations about venues within the preset area by user V. Sᵥⱼ represents an evaluation score obtained by evaluating a second service provider j by user V. Wᵤᵥ represents a similarity between user U and user V. When the average evaluation score of user U, an evaluation score of the second service provider j evaluated by user V, and the similarity between user U and user V are larger, the predicted evaluation value Pᵤⱼ of user U with respect to the second service provider j is higher.

The distance calculator 650 calculates a distance between a location of the specific user and a recommended venue recommendation information having a high predicted evaluation value based on the predicted evaluation value within the preset area. Here, the recommendation information is selected based on the similarities among the users and the evaluation scores of the users. When it is assumed that users with the similar weightings give 0 to 5 points as an evaluation score, the venue recommendation information with a high score, for example, 4 points or 5 points may be considered to be a recommend information. A distance between the location of the specific user and the recommendation information may be calculated based on the Euclidean distance formula. The distance between the location of the specific user and the recommendation information is calculated herein based on the Euclidean distance formula, but may be calculated by other methods. A method for calculating the distance between the location of the specific user and the recommendation information based on the Euclidean distance formula is expressed by Equation 4 below.

$${L}_{uj} ( Distance Between {CL}_{u} and {PL}_{uj} ) = \sqrt{{\sum }_{j = 1}^{m} {( {CL}_{u} - {PL}_{uj} )}^{2}} \qquad Equation 4$$

Lᵤⱼ represents a result obtained by calculating a distance between a current location of user U and a recommendation information based on the Euclidean distance formula. CLᵤ represents coordinates of the current location of user U. PLᵤⱼ represents coordinates of the recommendation information.

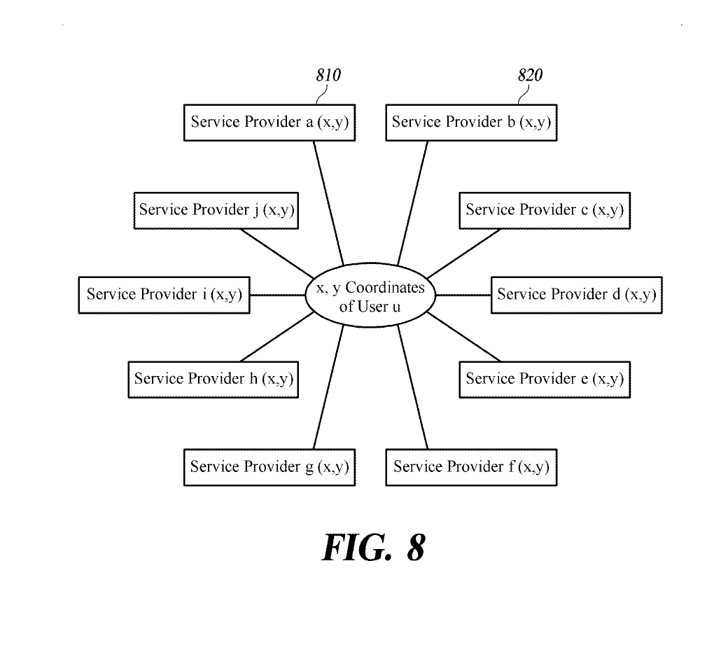

FIG. 8 is a diagram of a method for calculating a distance between a current location of user U and a recommendation information according to some embodiments.

FIG. 8 shows coordinates of the current location of user U and coordinates of the locations of recommendation informations. The distance calculator 650 may calculate distances among the current location of user U and recommendation informations a and b based on coordinates 810 of recommendation information ‘a’ and coordinates 820 of recommendation information ‘b’. A distance between the current location of user U and recommendation information ‘a’ is calculated, a distance between the current location of user U and recommendation information ‘b’ is calculated, and then one between recommendation informations ‘a’ and ‘b’ having a larger reciprocal of the calculated distance is determined. The one having the larger reciprocal may be considered to be the recommendation information closer to the current location of user U.

The recommended business extractor 650 selects a recommended business which is most suitable for a user, based on the weight information, the similarity information, the predicted value information, and the distance information and provides the selected recommended business to the user. A method for selecting a recommended venue is expressed by Equation 5 below.

$${V}_{u} = x {\sum }_{j = 1}^{m} {P}_{uj} + ɛ log \frac{1}{\sqrt{{\sum }_{j = 1}^{m} {( {CL}_{u} - {PL}_{uj} )}^{2}}} \\ x + ɛ = 1 \qquad Equation 5$$

Vᵤ represents a venue recommendation value of user U derived by the business recommending apparatus 130 using a location based SNS. To calculate the venue recommendation value of user U, a recommendation information extracted according to the predicted value of user U calculated from similarities among other users is obtained. A reciprocal of a calculated distance Lᵤⱼ between the current location CLᵤ of user U and the location PLᵤⱼ of the recommendation information is obtained and a logarithm value of the reciprocal is calculated. Further, the calculated distance Lᵤⱼ is compared with calculated distances among the current location of user U and locations of other recommendation informations, and a recommendation information having the largest calculated distance is obtained. Here, the recommendation information having the largest calculated distance may be determined to correspond to a venue that is closest to the current location CLᵤ of user U. A recommendation information closer to the current location of user U than other recommendation informations among the recommendation informations may be extracted as a recommended business and Vᵤ may be provided to user U.

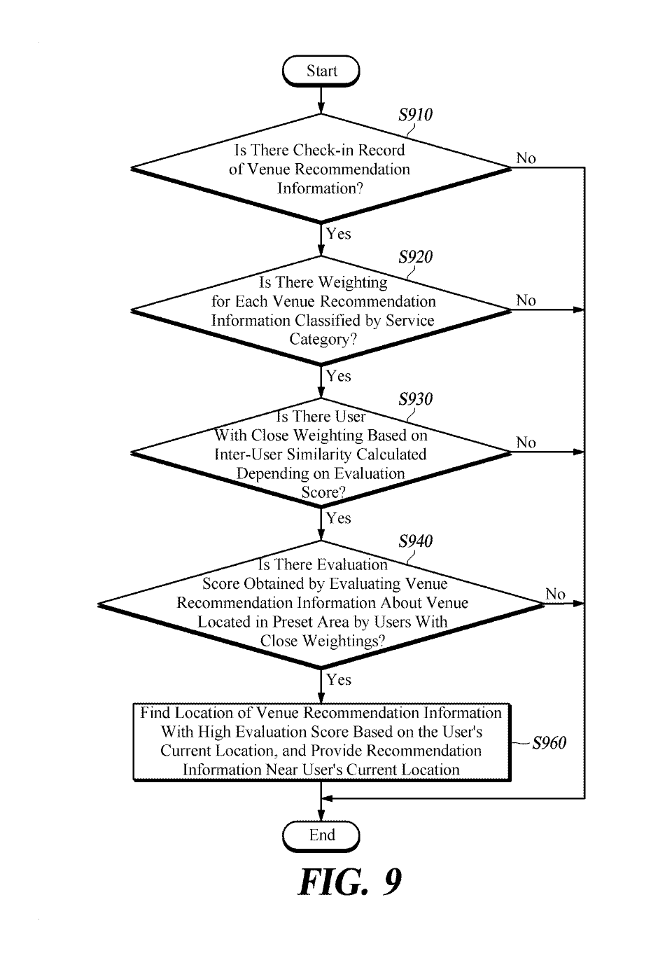

FIG. 9 is a flowchart of an operational process of a business recommendation unit according to some embodiments.

The check-in record aggregator 610 checks whether there is a check-in record of a venue recommendation information (S910).

According to the checking result in step S910, when there is the check-in record, the weight calculator 620 checks whether there is a weighting information indicating that a weight is assigned to each venue recommendation information classified by a service category based on the check-in record information (S920).

According to the checking result in step S920, when there is the weighting information, the similarity calculator 620 checks whether there is a user with a similar weight based on an inter-user similarity calculated depending on evaluation scores for venue recommendation informations within a preset area for each user (S930).

According to the checking result in step S930, when there is the user with the similar weighting, the predicted evaluation value calculator 640 checks whether there is an evaluation score obtained by evaluating a venue recommendation information on a venue located within a preset area by users with similar weightings (S940). Here, the venue recommendation information evaluated by the users with the similar weightings is selected based on the similarities among the users and the evaluation scores of the users. When it is assumed that users with the similar weightings give 0 to 5 points as an evaluation score, the venue recommendation information with a high score, for example, 4 points or 5 points may be considered to be a recommend information.

According to the checking result in step S940, when there is the venue recommendation information evaluated by the users with the close weightings, the recommended business extractor 660 determines a location of the venue recommendation information having a high evaluation score based on the current location of the user, and provides the recommendation information on a venue located close to the current location of the user (S950). When the recommendation information is provided, a recommendation service based on a location based social network service (LBSNS) ends. Further, a recommendation service based on the LBSNS ends when there is no check-in record in step S910, there is no weighting information in step S920, there is no user with the close weight in step S930, and there is the venue recommendation information evaluated by the users with the close weightings in step S940.

FIG. 9 illustrates that steps S910 to S950 are sequentially performed, but the process is not necessarily limited thereto.

Programmed source codes in Table 2 represent the process of FIG. 9.

TABLE 2
SELECT COUNT(*) CHECKIN_CNT
FROM CHECKIN_REVIEW
WHERE DATE_SUB(SYSDATE( ), INTERVAL 30 DAY) <= CHECKIN_DT AND UID=USERn
SELECT SCATE, (SELECT SCATE_NM FROM PLACE_CATE PC WHERE PC.SCATE=C.SCATE GROUP BY
SCATE) SCATE_NM, SUM(PLACE_ID_CNT) CNT
FROM(
SELECT A.PLACE_ID, COUNT(A.PLACE_ID) PLACE_ID_CNT, B.SCATE
FROM CHECKIN_REVIEW A LEFT JOIN PLACE B ON A.PLACE_ID=B.PLACE_ID
WHERE A.PLACE_ID<>″ AND UID=USER1
GROUP BY A.PLACE_ID
ORDER BY SCATE
) C
GROUP BY SCATE
ORDER BY SUM(PLACE_ID_CNT) DESC
LIMIT 10;
SELECT A.PLACE_ID, B.PLACE_NM, COUNT(A.PLACE_ID) PLACE_ID_CNT, B.SCATE, PS.SCORE
FROM CHECKIN_REVIEW A LEFT JOIN PLACE B ON A.PLACE_ID=B.PLACE_ID LEFT JOIN PLACE_SCORE
PS
ON B.PLACE_ID=PS.PLACE_ID
WHERE A.PLACE_ID<>″ AND A.UID=USER4 AND B.SCATE=Ak AND PS.SCORE>0
GROUP BY A.PLACE_ID
ORDER BY PS.SCORE DESC
/****Coordinates of current location of User 1 latitude: 37.497963, longitude : 127.027721****/
SELECT ‘RECOMMENDATION’ TYPE, A.PLACE_ID, B.PLACE_NM, B.SCATE, B.ADDR, B.LAT, B.LNG, B.SCORE
FROM CHECKIN_REVIEW A LEFT JOIN PLACE B ON A.PLACE_ID=B.PLACE_ID LEFT
JOIN PLACE_SCORE PS ON B.PLACE_ID=PS.PLACE_ID
WHERE A.PLACE_ID<>″ AND A.UID IN (USER1, USER2,USER3,USER4) AND B.SCATE=Ak AND
B.SCORE>0
GROUP BY A.PLACE_ID
ORDER BY (SQRT(POWER(69.1 * (B.LAT −37.497963), 2) + POWER(69.1* (B.LNG − 127.027721) *
COS(B.L
AT/57.3), 2)) * 1609.344)
LIMIT 0, 5

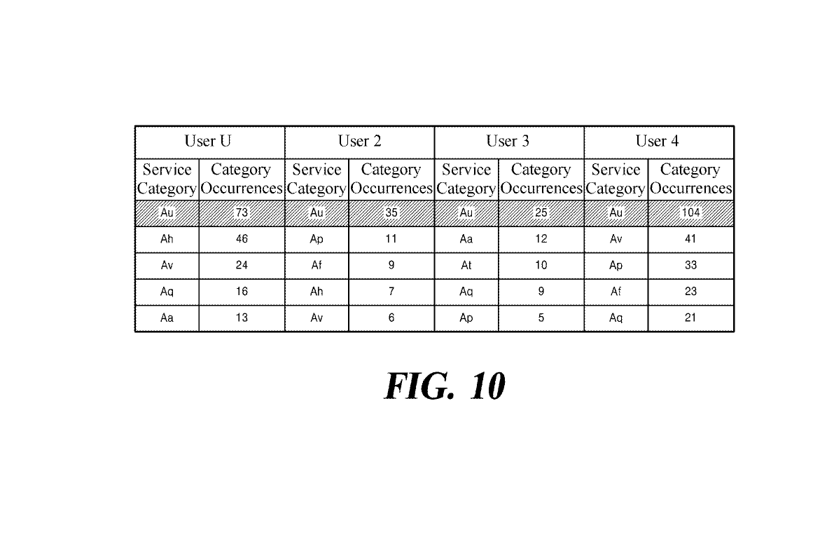

FIGS. 10 to 14 are diagrams of a recommendation process using a LBSNS for recommending a restaurant when the venue recommendation information is a restaurant information.

FIG. 10 is an exemplary diagram of a result of assigning a weight to a restaurant category by each user according to some embodiments.

Referring to FIG. 10 in which restaurant categories are divided according to the weightings of users, a service category corresponds to a name of the restaurant category, and the number of occurrences of the category refers to the number of occurrences of the category corresponding to a restaurant at which a user performs a check-in operation. Café Au has the largest number of category occurrences of user U that is 73. Café Au has also the largest number of category occurrences of user 2, user 3, and user 4, similar to user U. A restaurant category, for which it is determined that user U has the highest weight among restaurant categories, may be considered to be a café having the largest number of category occurrences of user U.

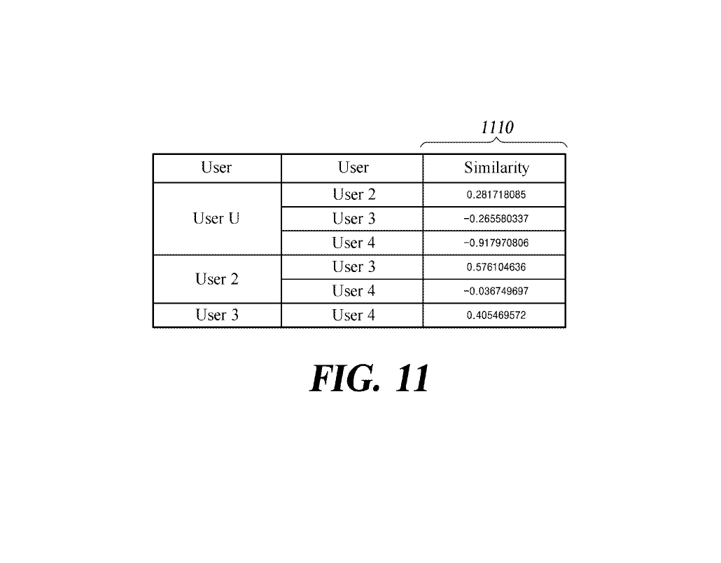

FIG. 11 is a diagram of the similarities among user U, user 2, user 3, and user 4.

User U, user 2, user 3, and user 4 are users having the highest weight for café as confirmed in FIG. 10. A similarity 1110 between users may be calculated by Equation 2 described above. Referring to the similarity 1110, it can be seen that a user having the highest similarity with user U is user 2 having a similarity of −0.265580337. Further, it can be seen that a user having the highest similarity with user 2 is user 4 having a similarity of −0.036749697, and a user having the highest similarity with user 3 is user 4 having a similarity of 0.405469572. Here, when the similarity is closer to 0, the similarity is considered to be higher.

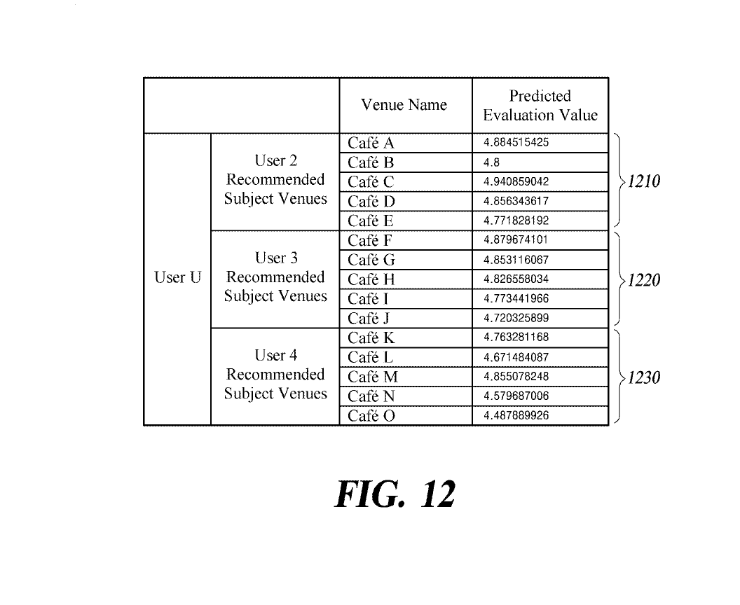

FIG. 12 is a diagram of predicted evaluation values obtained by predicting preferences of user U for cafés based on evaluation scores of user 2, user 3, and user 4 having the same weight as that of user U for a café.

Referring to the recommended venue 1210 of user 2, it can be seen that ‘café C’ obtains the highest predicted evaluation value, 4.940859042. Referring to the recommended venue 1220 of user 3, it can be seen that ‘café F’ obtains the highest predicted evaluation value, 4.879674101. Referring to the recommended venue 1230 of user 4, it can be seen that ‘café M’ obtains the highest predicted evaluation value, 4.855078248.

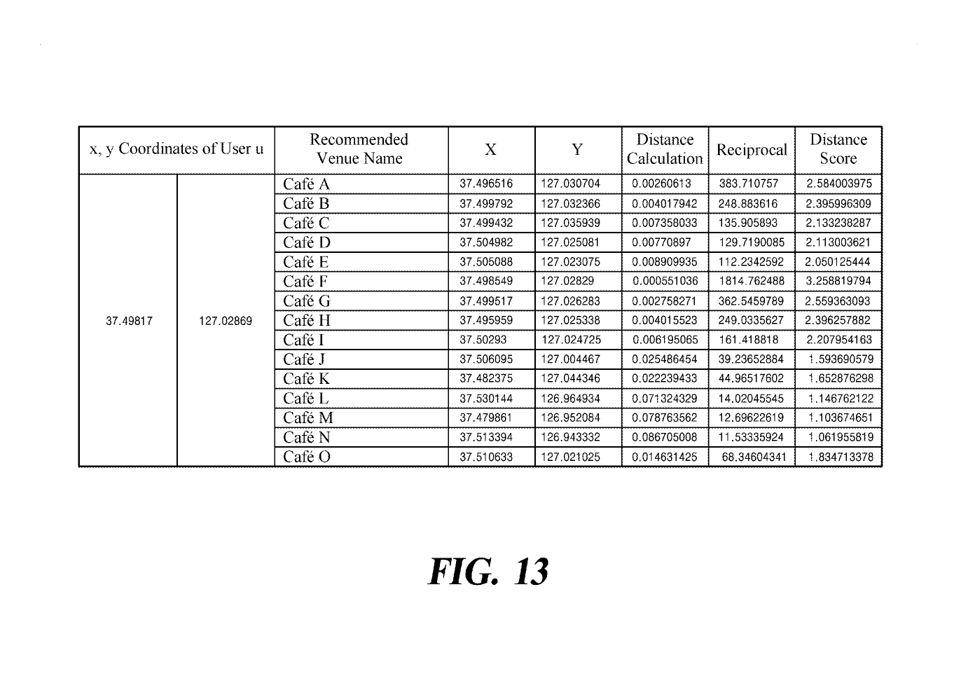

FIG. 13 is a diagram of measurement results of distance scores depending on distances among the current location of user U and recommended cafés.

The calculated distance scores represented in FIG. 13 are calculated by using the Euclidean distance formula according to some embodiments, but may be calculated by other methods. It can be seen from the distance scores that ‘café F’ is closest to user U.

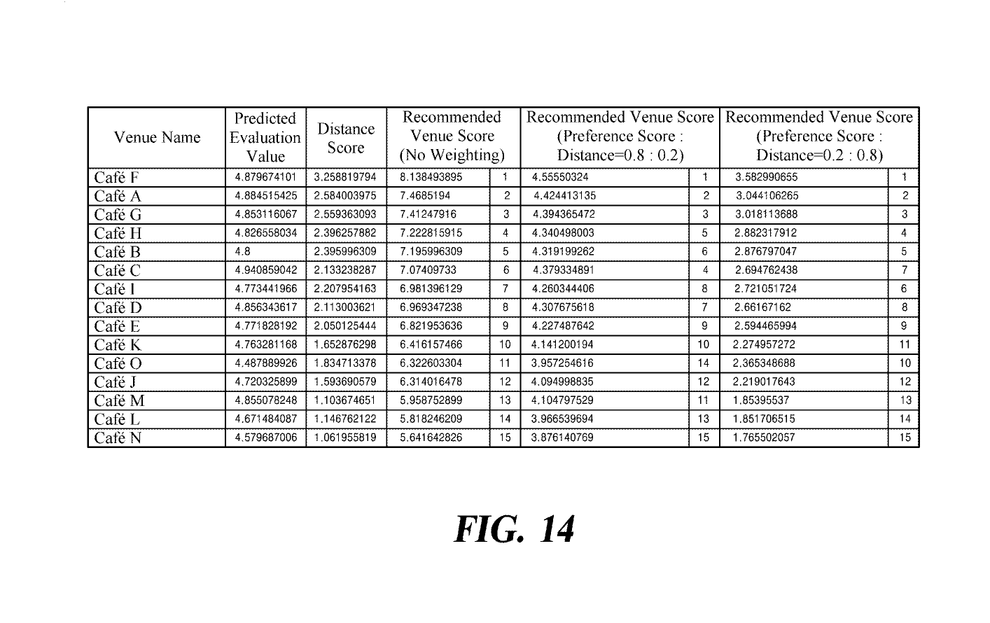

FIG. 14 is a diagram of recommended venues generated by applying ratios of the predicted evaluation values and the distance scores to recommended venue scores obtained by adding the predicted evaluation values and the distance scores.

The recommended venue score is obtained by adding the predicted evaluation value and the distance score. According to the result obtained based on the recommended venue score, café F, café A, café G, café H, café B, café C, and café I ranks first, second, third, fourth, fifth, sixth, and seventh, respectively. When ratios of the predicted evaluation value and the distance score to the recommended venue score are 0.8 and 0.2, it may be confirmed according to a result of calculation that café H, which has ranked fourth, falls to fifth. Further, when the ratios of the predicted evaluation value and the distance score to the recommended venue score are 0.2 and 0.8, it may be confirmed according to a result of calculation that café C, which has ranked sixth, falls to seventh.

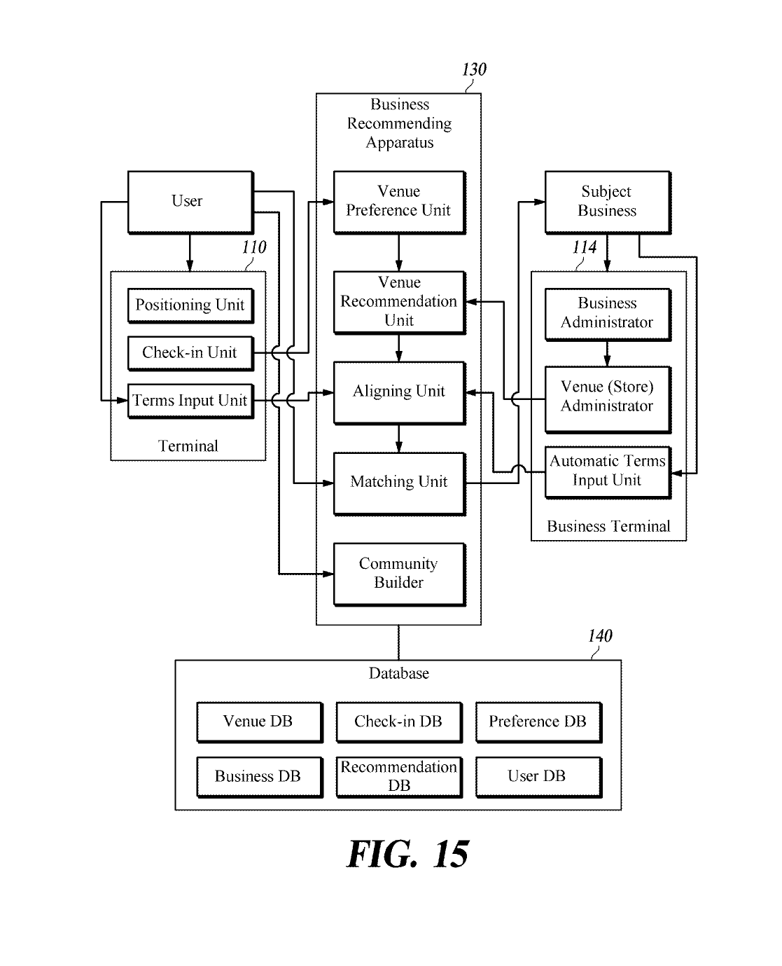

FIG. 15 is an exemplary diagram according to some embodiments.

The terminal 110 may be configured to include a ‘positioning unit’, a ‘check-in unit’, and a ‘terms input unit’ as illustrated in FIG. 15. The terminal 110 inputs a transaction information (a budget information, a participant number information, a date information, a memo information, and a location radius information with respect to a specific menu content) according to a user's operation or command. The terminal 110 transmits the transaction information to the business recommending apparatus 130, and receives and displays a business recommendation information and a venue recommendation information corresponding to the transaction information from the business recommending apparatus 130. In this case, the terminal 110 displays the business recommendation information and the venue recommendation information in such a manner as to align the business recommendation information and the venue recommendation information (in an ascending order or a descending order) according to specific terms (a menu information, the budget information, the participant number information, the date information, the memo information, and the location radius information). Then, the terminal 110 receives a selection information, which is any one selected from the business recommendation information according to the user's operation or command, and transmits the selection information to the business recommending apparatus 130. Then, the terminal 110 receives and displays an award information with respect to the selection information from the business recommending apparatus 130. Here, the award information is an information indicating that a bidding information is selected and transmitted to the corresponding business terminal 114.

The business recommending apparatus 130 may be configured to include a ‘venue preference unit’, a ‘venue recommendation unit’, an ‘aligning unit’, a ‘matching unit’, and a ‘community builder,’ as illustrated in FIG. 15. The business recommending apparatus 130 receives a transaction information with respect to a menu content from the terminal 110, generates a venue recommendation information based on a bidding information corresponding to the transaction information, identifies, among the generated venue recommendation information, a business recommendation information matching a preference information corresponding to a subscriber information of the terminal 110, transmits the business recommendation information to the terminal 110 through a reverse auction scheme, performs an award process of a selection information selected from the business recommendation information, and transmits an award information to the business terminal 114 corresponding to the selection information.

The business terminal 114 may be configured to include a ‘ business administrator’, a ‘venue administrator’, and an ‘automatic terms input unit,’ as illustrated in FIG. 15. The business terminal 114 may be configured to register a bidding information (a business information, an address information, a phone number information, a menu picture information, a flagship dish information, an open hours information, a price terms information, a discount rate information, and a location radius information) in the business recommending apparatus 130, and upon receiving the transaction information from the terminal 110, automatically transmit a bidding information corresponding to the transaction information to the terminal 110. When the business terminal 114 connects to the business recommending apparatus 130, inputs a bidding information, and sets an ‘automatic bidding,’ the business recommending apparatus 130 may perform the automatic bidding based on a terms information included in the bidding information registered by the business terminal 114. In the meantime, when the terminal 110 transmits the transaction information, the business terminal 114 may receive the transaction information from the business recommending apparatus 130 in real time, and then transmit a bidding information corresponding to the transaction information to the business recommending apparatus 130 according to an administrator's operation or command.

The database 140 may be configured to include a ‘venue database,’ a ‘check-in database,’ a ‘preference database,’ a ‘business database,’ a ‘recommendation database’ and a ‘user database,’ as illustrated in FIG. 15.

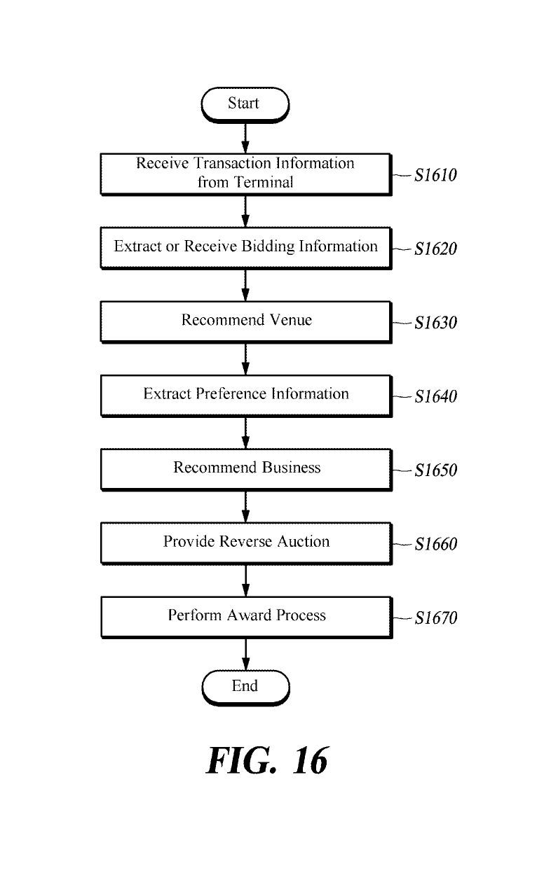

FIG. 16 is a flowchart of a method for recommending a business by using a reverse auction according to some embodiments.

The business recommending apparatus 130 receives a transaction information with respect to a menu content from the terminal 110 (step S710). In step S1610, the terminal 110 inputs a transaction information (a budget information, a participant number information, a date information, a memo information, and a location radius information with respect to a specific menu content) according to a user's operation or command. The terminal 110 transmits the transaction information to the business recommending apparatus 130, and receives and displays a business recommendation information and a venue recommendation information corresponding to the transaction information from the business recommending apparatus 130. In this case, the terminal 110 displays the business recommendation information and the venue recommendation information in such a manner as to align the business recommendation information and the venue recommendation (in an ascending order or a descending order) according to specific terms (a menu information, the budget information, the participant number information, the date information, the memo information, and the location radius information). Then, the terminal 110 receives a selection information which is any one selected from the business recommendation information according to the user's operation or command, and transmits the selection information to the business recommending apparatus 130. Then, the terminal 110 receives and displays an award information with respect to the selection information from the business recommending apparatus 130.

The business recommending apparatus 130 extracts a bidding information corresponding to the transaction information from a previously registered information or receives the bidding information from the business terminal 114 in real time (S1620). In step S1620, the business recommending apparatus 130 extracts, among the previously registered business informations, an information corresponding to the transaction information received from the terminal 110, as a bidding information or receives a bidding information from the business terminal 114 in real time. The business recommending apparatus 130 extracts, from a terms information included in the previously registered business informations, an information coinciding with a preset terms information included in the transaction information within a preset range, as the bidding information. Further, the business recommending apparatus 130 receives a current location information from the terminal 110, and transmits the transaction information to a business terminal 114 locationed within the preset range based on the current location information.

In the meantime, in step S1620, the business terminal 114 may be configured to register a bidding information (a business information, an address information, a phone number information, a menu picture information, a flagship dish information, an open hours information, a price terms information, a discount rate information and a location radius information) in the business recommending apparatus 130, and when receiving the transaction information from the terminal 110, automatically transmit a bidding information corresponding to the transaction information to the terminal 110. When the business terminal 114 connects to the business recommending apparatus 130, inputs the bidding information, and sets an ‘automatic bidding,’ the business recommending apparatus 130 may perform the ‘automatic bidding based on a terms information included in the bidding information registered by the business terminal 114. In the meantime, when the terminal 110 transmits the transaction information, the business terminal 114 may receive the transaction information from the business recommending apparatus 130 in real time, and then transmit a bidding information corresponding to the transaction information to the business recommending apparatus 130 according to an administrator's operation or command.

The business recommending apparatus 130 generates a venue recommendation information based on the bidding information corresponding to the transaction information (S1630). In step S1630, the business recommending apparatus 130 collects the bidding information and filters a business information out of the preset range based on the current location information received from the terminal 110 to generate the venue recommendation Information.

The business recommending apparatus 130 extracts a preference information, corresponding to a subscriber information of the terminal 110, from the generated venue recommendation information (S1640). In step S1640, the business recommending apparatus 130 calculates the preference information based on a review information or a venue evaluation information corresponding to the subscriber information of the terminal 110. The business recommendation unit 130 calculates a preference POI information based on a POI information included in the review information or the venue evaluation information, calculates a preference local area information based on a local area information included in the review information or the venue evaluation information, or calculates a preference menu information based on a menu information included in the review information or the venue evaluation information. Then, with respect to the calculated preference POI information, preference local area information and preference menu information, the business recommendation unit 130 identifies at least one coincident information from the POI information, the local area information and the menu information included in the venue recommendation information, as a business recommendation information.

The business recommending apparatus 130 identifies, from the generated venue recommendation information, a business recommendation information matching a preference information corresponding to the subscriber information of the terminal 110 (S1650). The business recommending apparatus 130 transmits the business recommendation information to the terminal 110 through a reverse auction scheme (S1660). In step S1660, the business recommending apparatus 130 transmits the business recommendation information to the terminal 110 in such a manner as to align the business recommendation information according to a preset terms information. The business recommending apparatus 130 performs an award process of a selection information selected from the business recommendation information and transmits an award information to a business terminal 114 corresponding to the selection information (S1670). In step 1670, the business recommending apparatus 130 receives the selection information from the terminal 110, performs the award process of a business information corresponding to the selection information selected from the business recommendation information and transmits the award information to the business terminal 114 corresponding to the business information.

FIG. 16 illustrates that steps S1610 to S1670 are sequentially performed, which is provided merely for the purpose of illustrating the technical spirit of the present disclosure. Various modifications and variations may be made by those skilled in the art without departing from the essential characteristic of the present disclosure, for example, such that the order illustrated in FIG. 16 is changed and the process is performed in the changed order or one or more of steps S1610 to S1670 are performed in parallel. The process illustrated in FIG. 16 is not limited to the time-sequential order.

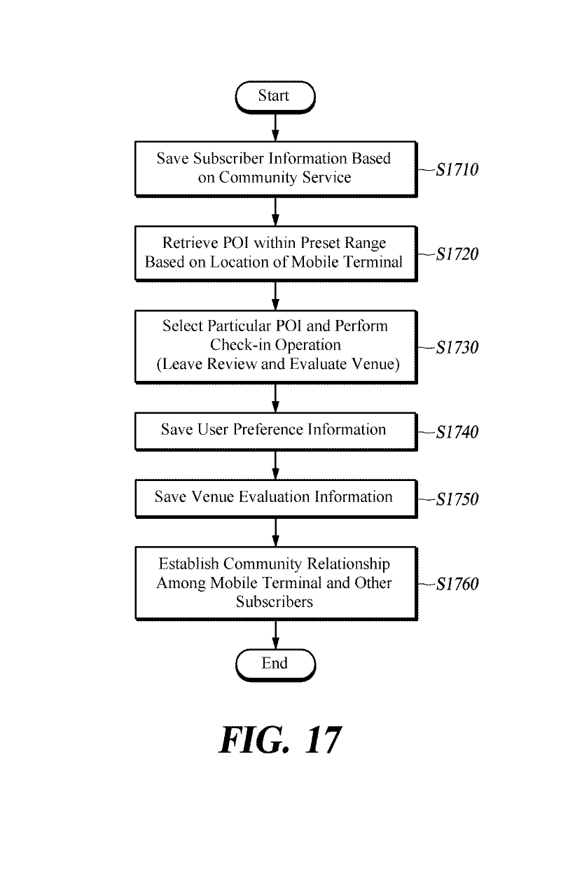

As described above, the method for recommending a business by using a reverse auction according to some embodiments illustrated in FIG. 16 may be implemented by programs and recorded in a computer readable recording medium. The computer readable recording medium, in which the program for implementing the method for recommending a business by using a reverse auction according to some embodiments is recorded, includes all types of recording devices in which data readable by a computer system is stored. FIG. 17 is a flowchart of a method for performing a check-in operation for venues according to some embodiments.

The business recommending apparatus 130 stores a subscriber information of the terminal 110 subscribing to a community service (SNS) (S1710). Since it is basically required to subscribe to a community service (SNS) in order to use the community application 112 installed in the terminal 110, the business recommending apparatus 130 stores the subscriber information of the terminal 110 subscribing to the community service (SNS). Here, the subscriber information includes at least one of an ‘account information (an ID information, and a password information),’ a ‘name information,’ an ‘email information,’ a ‘telephone number information’ and a ‘resident registration number information.’

The business recommending apparatus 130 generates an information regarding a result of retrieving a POI within a preset range based on a current location information of the terminal 110 (S1720). For example, when the current location information of the terminal 110 is ‘Gangnam station’ and the preset range is ‘2 km,’ the business recommending apparatus 130 retrieves POIs located within a radius of ‘2 km’ based on ‘Gangnam station,’ and generates a retrieval result information including the retrieved POIs.

The business recommending apparatus 130 selects, from the retrieval result information, a POI to which the review information or the venue evaluation information is assigned based on the subscriber information and performs a check-in operation (S1730). When the review information or the venue evaluation information is assigned to a particular POI information of the retrieval result information based on the subscriber information of the terminal 110, the business recommending apparatus 130 selects only the corresponding POI and performs the check-in operation therefor.

The business recommending apparatus 130 calculates and stores a preference information based on the review information or the venue evaluation information (S1740). For example, the business recommending apparatus 130 calculates and stores a preference POI information with respect to a POI to which the review information or the venue evaluation information is assigned, calculates and stores a preference local area information based on a local area information including the corresponding POI, or calculates and stores a preference menu information based on a menu information including the corresponding POI.

The business recommending apparatus 130 stores the review information or the venue evaluation information separately from the preference information (S1750). The business recommending apparatus 130 shares the review information or the venue evaluation information among the terminal 110 and terminals of other subscribers to build a community (S1760). Here, the community service refers to a service providing a communication that allows a user to establish a community relationship based on a social link linked with a POI corresponding to a location of the user to share an information such as an image, a text and a moving image or do activities such as chatting, data transmission, advertisement, marketing and holding an event.

FIG. 17 illustrates that steps S1710 to S1760 are sequentially performed, which is provided merely for the purpose of illustrating the technical spirit of the present disclosure. Various modifications and variations may be made by those skilled in the art without departing from the essential characteristic of the present disclosure, for example, such that the order illustrated in FIG. 17 is changed and the process is performed in the changed order or one or more of steps S1710 to S1760 are performed in parallel. The process illustrated in FIG. 17 is not limited to the time-sequential order.

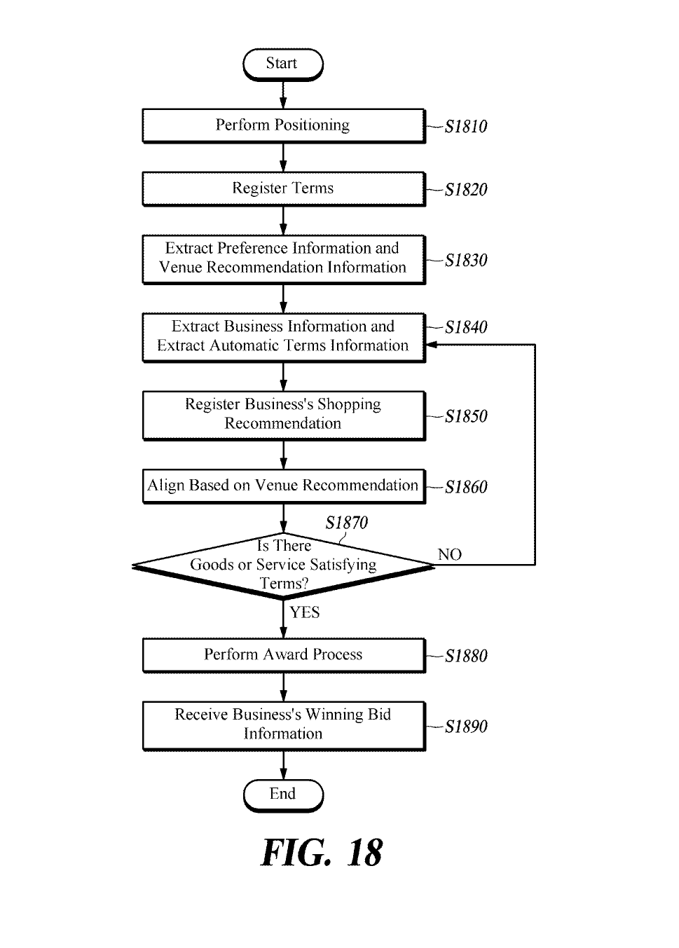

FIG. 18 is a flowchart of a method for reverse auction based on a community service according to some embodiments.

The business recommending apparatus 130 receives a current location information from the terminal 110 (S1810). In step S1810, the business recommending apparatus 130 may receive the current location information of the terminal 110 from the same or a separate positioning device.

The terminal 110 registers a transaction information with respect to a menu content to the business recommending apparatus 130 according to a user's operation or command (S1820). In step S1820, the terminal 110 inputs a transaction information (a budget information, a participant number information, a date information, a memo information, and a location radius information with respect to a specific menu content) according to the user's operation or command. The terminal 110 transmits the transaction information to the business recommending apparatus 130, and receives and displays a business recommendation information and a venue recommendation information corresponding to the transaction information from the business recommending apparatus 130. In this case, the terminal 110 displays the business recommendation information and the venue recommendation information in such a manner as to align the business recommendation information and the venue recommendation information (in an ascending order or a descending order) according to specific terms (a menu information, the budget information, the participant number information, the date information, the memo information, and the location radius information). Then, the terminal 110 receives a selection information which is any one selected from the business recommendation information according to a user's operation or command, and transmits the selection information to the business recommending apparatus 130. Then, the terminal 110 receives and displays an award information regarding the selection information from the business recommending apparatus 130.

The business recommending apparatus 130 extracts a preference information corresponding to the subscriber information of the terminal 110, and generates a venue recommendation information (S1830). In step S1830, the business recommending apparatus 130 calculates the preference information based on a review information or a venue evaluation information corresponding to the subscriber information of the terminal 110. The business recommendation unit 130 calculates a preference POI information based on a POI information included in the review information or the venue evaluation information, calculates a preference local area information based on a local area information included in the review information or the venue evaluation information, or calculates a preference menu information based on a menu information included in the review information or the venue evaluation information. In the meantime, in step S1830, the business recommending apparatus 130 extracts a bidding information corresponding to the transaction information from a previously registered information or receives a bidding information from the business terminal 114 in real time, and the business recommending apparatus 130 generates a venue recommendation information based on the bidding information corresponding to the transaction information.

The business recommending apparatus 130 extracts a business information and extracts an automatic terms information (S1840). The business recommending apparatus 130 may extract the bidding information corresponding to the transaction information from the previously registered information (automatic terms information) or receive the business information from the business terminal 114 in real time. The business recommending apparatus 130 registers a business's shopping recommendation (S1850). The business recommending apparatus 130 may identifies, from the generated venue recommendation information, a business recommendation information matching the preference information corresponding to the subscriber information of the terminal 110, and register the identified business recommendation information as the ‘business's shopping recommendation.’ In this case, with respect to the calculated preference POI information, preference local area information and preference menu information, the business recommendation unit 130 may select at least one coincident information from the POI information, the local area information, and the menu information included in the venue recommendation information, as the business recommendation information.

When the business recommending apparatus 130 transmits the business recommendation information (business's shopping recommendation) through a reverse auction scheme to the terminal 110, the terminal 110 aligns and displays the business recommendation information (business's shopping recommendation) based on venue recommendation (S1860). The business recommending apparatus 130 may transmit the business recommendation information (business's shopping recommendation) to the terminal 110 in such a manner as to align the business recommendation information according to a preset terms information, but the present disclosure is not limited thereto. The terminal 110 may align and display the business recommendation information according to the preset terms information.

The terminal 110 checks whether there is goods or a service satisfying terms in the business recommendation information (business's shopping recommendation) displayed by the user's operation or command (S1870). Upon checking in S1870, when there is goods or a service satisfying the terms in the displayed business recommendation information (business's shopping recommendation), the terminal 110 transmits a selection information corresponding to the goods or service to the business recommending apparatus 130. The business recommending apparatus 130 performs an award process of the selection information selected from the business recommendation information (S1880). The business recommending apparatus 130 transmits an award information to the business terminal 114 corresponding to the selection information (S1890). In step S1890, the business recommending apparatus 130 receives the selection information from the terminal 110, performs the award process of a business information, corresponding to the selection information, from the business recommendation information and transmits an award information to the business terminal 114 corresponding to the business information.

FIG. 18 illustrates that steps S1810 to S1890 are sequentially performed, which is provided merely for the purpose of illustrating the technical spirit of the present disclosure. Various modifications and variations may be made by those skilled in the art without departing from the essential characteristic of the present exemplary embodiment, for example, such that the order illustrated in FIG. 18 is changed and the process is performed in the changed order or one or more of steps S1810 to S1890 are performed in parallel. The process illustrated in FIG. 18 is not limited to the time-sequential order.

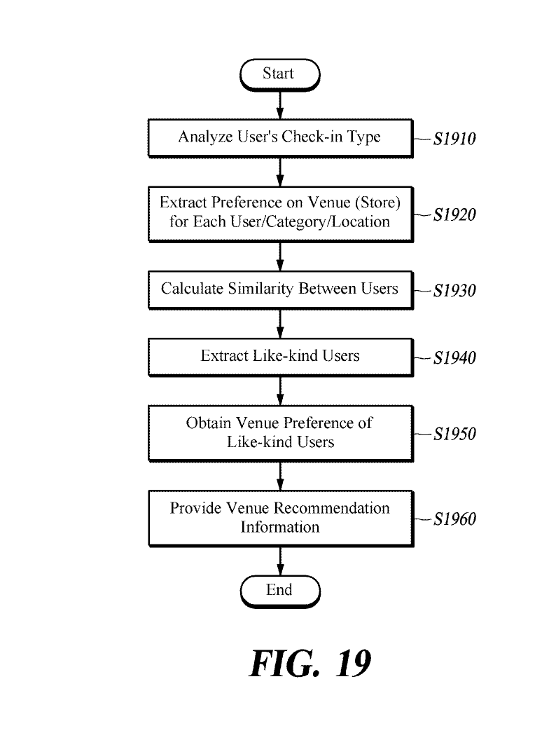

FIG. 19 is a flowchart of a method for checking a user's preference according to some embodiments.

The business recommending apparatus 130 identifies a check-in pattern for check-in (S1910). The business recommending apparatus 130 identifies the check-in pattern in which the subscriber performs a check-in operation. The business recommending apparatus 130 extracts a preference on a venue (store) for each user/category/location (S1920). The business recommending apparatus 130 may extract, as a preference information, a POI preference information frequently selected for each user (user account), extract a POI preference information frequently selected for each category (‘Korean food’, ‘Western food’, ‘Chinese food’, and the like), or extract a POI preference information for each location (‘Seoul’, ‘Gyeonggi-do’, and the like).

The business recommending apparatus 130 calculate a similarity pattern between subscriber informations based on the check-in pattern (S1930). The business recommending apparatus 130 performs a check-in operation at a POI to which the review information or the venue evaluation information is assigned based on the subscriber information of the terminal 110 in the community service (SNS), and collects a corresponding check-in information, thereby identifying the check-in pattern. The business recommending apparatus 130 may select only a subscriber information of which a check-in pattern coincides with the identified check-in pattern by a preset percentage or more and calculate a similarity pattern between the corresponding subscribers.

The business recommending apparatus 130 extracts a like-kind subscriber information based on the similarity pattern (S1940). The business recommending apparatus 130 may extract all of the subscriber informations having the calculated similarity pattern and group the subscriber informations as a kind of groups, and extract the group as the like-kind subscriber information.

The business recommending apparatus 130 calculates at least one of the preference POI information, the preference local area information, and the preference menu information with respect to the like-kind subscriber information as the preference information (S1950). The business recommending apparatus 130 generates a venue recommendation information based on the preference information (S1960). The business recommending apparatus 130 may reflect the preference information to the process for receiving the transaction information from the terminal 110 and generating the venue recommendation information based on the bidding information corresponding to the transaction information.

FIG. 19 illustrates that steps S1910 to S1960 are sequentially performed, which is provided merely for the purpose of illustrating the technical spirit of the present disclosure. Various modifications and variations may be made by those skilled in the art without departing from the essential characteristic of the present disclosure, for example, such that the order illustrated in FIG. 19 is changed and the process is performed in the changed order or one or more of steps S1910 to S1960 are performed in parallel. The process illustrated in FIG. 19 is not limited to the time-sequential order.

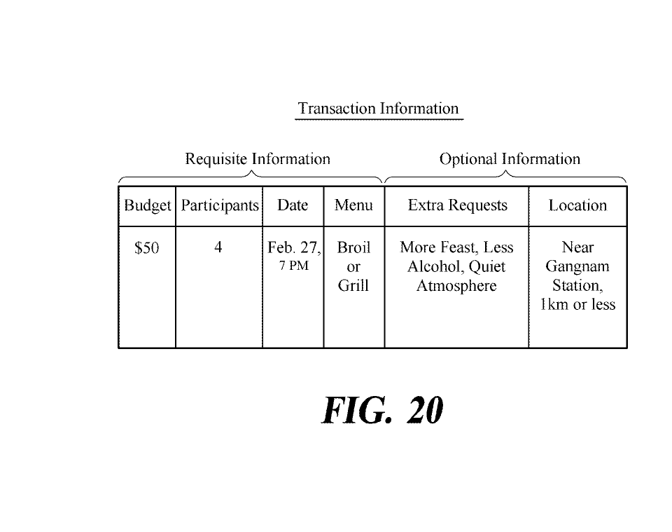

FIG. 20 is an exemplary diagram of a transaction information according to some embodiments.

The ‘transaction information’ includes, as illustrated in FIG. 20, a ‘budget information,’ a ‘participant number information,’ and a ‘date information’ as a requisite Information with respect to a menu content, and a ‘memo information,’ a ‘location radius information’ as an optional information. With regard to the transaction information, the terminal 110 may input ‘$50’ as the ‘budget information,’ ‘4’ as the ‘participant number information,’ ‘Feb. 27, 7 PM’ as the ‘date information,’ ‘more feast, less alcohol, quiet atmosphere’ as the ‘memo information,’ and ‘near Gangnam Station, 1 km or less’ as the ‘location radius information.’

The business recommending apparatus 130 according to some embodiments provides a retrieval service in which a location based service, a terms information, and a business information are combined in a mobile environment to the terminal 110. The business recommending apparatus 130 extracts a preference information by using a record information which is generated while the user performs a check-in operation on the basis of a location based community service (SNS) and it provides a retrieval result by using a venue recommendation information. The business recommending apparatus 130 may swiftly provide a customized retrieval result with high accuracy and reliability to the user. Further, goods or a service is automatically retrieved by using a goods or service terms function automatically set by a business (business terminal 114) and recommended to the user.

In this case, the users access the business recommending apparatus 130 through the terminal 110 and perform an check-in operation (an action of pointing out a location and leaving a comment) in ordinary times. For example, when an information is input saying ‘Today, I am in New York steakhouse to have a steak which tastes great’, the business recommending apparatus 130 may extract a preference for each user based on the information, extract a like-kind subscriber information of the terminal 110 by using a similarity function between users, and derive a venue recommendation information by using the information.

On the other hand, the user registers a new deal (new transaction information) in the business recommending apparatus 130 by using the terminal 110 (such as, ‘I want to host broil or grill on a budget of $50 for five, at 7 PM on 27. Near Gangnam station’). In this case, the information may be shared among users through the community service (SNS) by the business recommending apparatus 130.

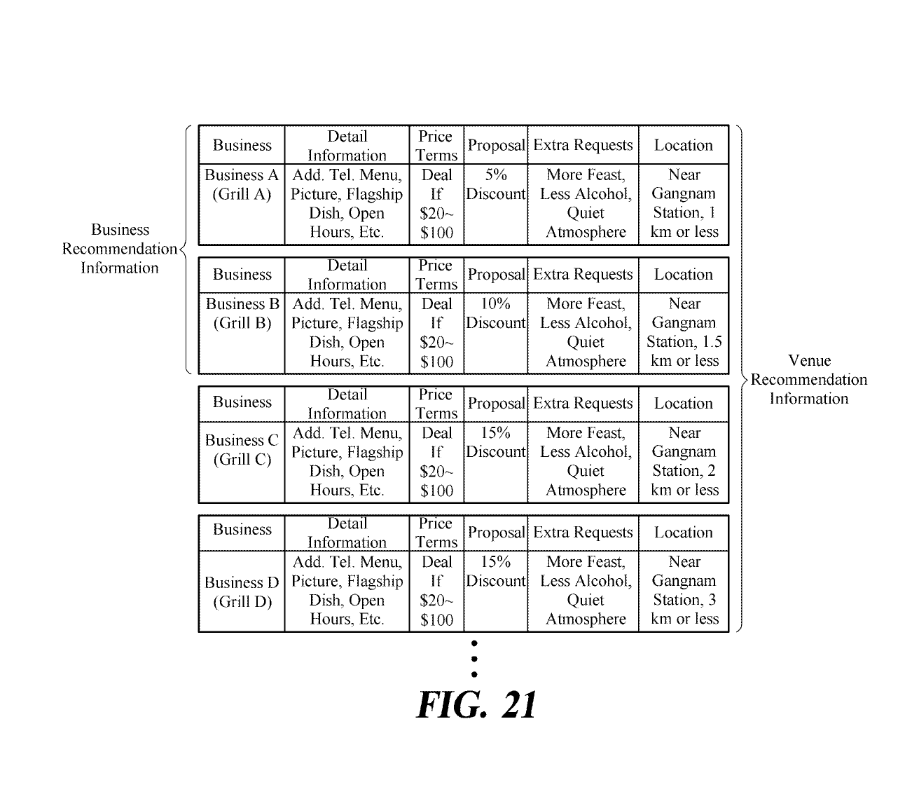

FIG. 21 is an exemplary diagram of a venue recommendation information and a business recommendation information according to some embodiments.

The ‘bidding information’ includes, as illustrated in FIG. 21, at least one of a ‘business information,’ a ‘detail information’ (an ‘address information,’ ‘telephone number information,’ ‘menu picture information,’ ‘flagship dish information,’ ‘open hours information’), a ‘price terms information,’ a ‘discount rate information,’ and a ‘location radius information.’ With regard to the bidding information, the business terminal 114 inputs informations of ‘business A,’ ‘business B,’ ‘business C,’ and ‘business D’ as the ‘business information,’ an ‘address information,’ a ‘telephone number information,’ a ‘menu picture information,’ a ‘flagship dish information,’ an ‘open hours information,’ etc. as the ‘detail information,’ an information such as ‘$20 to $100’ and the like as the ‘price terms information,’ an information such as ‘5% discount,’ ‘10% discount,’ ‘15% discount,’ and the like as ‘the discount rate information,’ and an information such as ‘near Gangnam station, 1 km or less,’ ‘near Gangnam station, 1.5 km or less,’ ‘near Gangnam station, 2 km or less,’ ‘near Gangnam station, 3 km or less,’ and the like as the ‘location radius information.’

Further, as illustrated in FIG. 21, the venue recommendation information may include the ‘business A,’ the ‘business B,’ the ‘business C’ and ‘business D,’ and the business recommendation information may include only the ‘business A,’ and ‘business B’ matching the preference information of the venue recommendation information. After the ‘transaction information’ of businesses as illustrated in FIG. 21 is recognized, automatically registered informations and new recommendation informations (bidding informations) regarding a deal corresponding to the transaction information may be aligned (in this case, aligned by applying a user's preference and the venue recommendation information) and displayed. The user selects and awards a desired one from the venue recommendation informations if any. It is also notified immediately to the business (business terminal 114) that the venue recommendation information desired by the user is awarded. The award information may be shared with other subscribers through the community service (SNS).

Although exemplary embodiments of the present disclosure have been described for illustrative purposes, those skilled in the art will appreciate that various modifications, additions and substitutions are possible. Therefore, exemplary embodiments of the present disclosure have been described for the sake of brevity and clarity. Accordingly, one of ordinary skill would understand that the scope of the claimed invention is not to be limited by the explicitly described above embodiments but by the claims and equivalents thereof.

### CROSS-REFERENCE TO RELATED APPLICATION

If applicable, this application claims priority under 35 U.S.C §119(a) of Patent Application No. 10-2013-0025271, filed on Mar. 8, 2013 and Patent Application No. 10-2014-0018022, filed on Feb. 17, 2014 in Korea, the entire contents of which are incorporated herein by reference. In addition, this non-provisional application claims priority in countries, other than the U.S., with the same reason based on the Korean Patent Applications, the entire contents of which are hereby incorporated by reference.

1. An apparatus for recommending a business, comprising:
a venue recommendation unit configured to receive a transaction information with respect to a menu content from a terminal, and generate a venue recommendation information based on a bidding information corresponding to the transaction information;
a business recommendation unit configured to identifies, from the generated venue recommendation information, a business recommendation information matching a preference information corresponding to a subscriber information of the terminal;
a reverse auction provider configured to transmit the business recommendation information to the terminal through a reverse auction scheme; and
an award processor configured to perform an award process of a selection information selected from the business recommendation information, and transmit an award information to a business terminal corresponding to the selection information.

2. The apparatus of claim 1, wherein the business recommendation unit comprises:
a check-in record aggregator configured to collect a check-in record information of the venue recommendation information from the terminal;
a weight calculator configured to calculate a weight for each preset service category based on the check-in record information;
an evaluation similarity calculator configured to extract an evaluation score for each venue recommendation information, and calculate an evaluation similarity between terminals included in the terminal based on the evaluation score and the weighting;
a predicted evaluation value calculator configured to calculate a predicted evaluation value of the venue recommendation information within a preset area based on the evaluation score and the evaluation similarity;
a distance calculator configured to calculate a distance between a location information of a specific terminal among the terminals within the preset area and a location information of a recommendation information extracted according to the predicted evaluation value; and
a recommended business extractor configured to generate the business recommendation information based on the predicted evaluation value and the distance.

3. The apparatus of claim 2, wherein the weight calculator is configured to calculate the weight by using the number of service categories checked in by a first terminal among the terminals and the number (ufᵥₖ) of occurrences of a specific category (k) in a check-in record information of the first terminal for each service category checked in by the first terminal.

4. The apparatus of claim 2, wherein the evaluation similarity calculator is configured to calculate the evaluation similarity based on the venue recommendation information with an evaluation score (Sᵤⱼ) of a second terminal among the terminals for a first service provider (i), an average evaluation score (Sᵤ) of the second terminal for the service provider, an evaluation score (Sᵥᵢ) of the first terminal for the first service provider (i), and an average evaluation score (Sᵥ) of the first terminal for the service provider.

5. The apparatus of claim 1, wherein the venue recommendation unit is configured to extract, from a previously registered business information, an information corresponding to the transaction information, as the bidding information or receive the bidding information from the business terminal in real time.

6. The apparatus of claim 1, wherein the venue recommendation unit is configured to extract, from a terms information included in a previously registered business information, an information coinciding with a preset terms information included in the transaction information within a preset range, as the bidding information.

7. The apparatus of claim 1, wherein the venue recommendation unit is configured to analyze a natural language included in the transaction information to generate a natural language analysis result, and extract, from a terms information included in a previously registered business information, an information coinciding with the natural language analysis result within a preset range, as the bidding information.

8. The apparatus of claim 1, wherein the venue recommendation unit is configured to receive a current location information from the terminal, and transmit the transaction information to the business terminal located within a preset range based on the current location information.

9. The apparatus of claim 1, wherein the venue recommendation unit is configured to collect the bidding information and filter a business information out of the preset range based on the current location information received from the terminal to generate the venue recommendation information.

10. The apparatus of claim 1, wherein the award processor is configured to receive the selection information from the terminal, perform an award process of a business information, corresponding to the selection information, among the business recommendation information, and transmit the award information to the business terminal corresponding to the business information.

11. A method for recommending a business by a business recommending apparatus, comprising:
performing a venue recommendation comprising:
receiving a transaction information with respect to a menu content from a terminal, and
generating a venue recommendation information based on a bidding information corresponding to the transaction information;
performing a business recommendation, comprising identifying, from the generated venue recommendation information, a business recommendation information matching a preference information corresponding to a subscriber information of the terminal;
providing a reverse auction, comprising transmitting the business recommendation information to the terminal through a reverse auction scheme; and
performing an award process comprising:
performing an award process of a selection information selected from the business recommendation information, and
transmitting an award information to a business terminal corresponding to the selection information.
